(19) United States
(12) Patent Application Publication
(10) Pub. No.: US 2020/0097257 A1
(43) Pub. Date: Mar. 26, 2020

(54) ELECTRONIC CALCULATING DEVICE ARRANGED TO CALCULATE THE PRODUCT OF INTEGERS

(71) Applicant: KONINKLIJKE PHILIPS N.V., EINDHOVEN (NL)

(72) Inventors: HENDRIK DIRK LODEWIJK HOLLMANN, VALKENSWAARD (NL); SEBASTIAAN JACOBUS ANTONIUS DE HOOGH, OOSTERHOUT (NL); PAULUS MATHIAS HUBERTUS MECHTILDIS ANTONIUS GORISSEN, EINDHOVEN (NL); LUDOVICUS MARINUS GERARDUS MARIA TOLHUIZEN, WAALRE (NL); RONALD RIETMAN, EINDHOVEN (NL)

(21) Appl. No.: 16/468,124

(22) PCT Filed: Dec. 7, 2017
(86) PCT No.: PCT/EP2017/081900

§ 371 Date: Jun. 10, 2019

(30) Foreign Application Priority Data
Dec. 12, 2016 (EP) 16203457.3

(51) Int. Cl. G06F 7/72

(52) U.S. Cl. CPC G06F 7/729; G06F 7/723

(57) ABSTRACT

An electronic calculating device (100; 200) arranged to calculate the product of integers, the device comprising a storage (110) configured to store integers (210, 220) in a multi-layer residue number system (RNS) representation, the multi-layer RNS representation having at least an upper layer RNS and a lower layer RNS, the upper layer RNS being a residue number system for a sequence of multiple upper moduli (Mᵢ), the lower layer RNS being a residue number system for a sequence of multiple lower moduli (mᵢ), an integer (x) being represented in the storage by a sequence of multiple upper residues (xᵢ=(x)_{Mi}; 211, 221) modulo the sequence of upper moduli (Mᵢ), upper residues (xⱼ; 210.2, 220.2) for at least one particular upper modulus (Mⱼ) being further-represented in the storage by a sequence of multiple lower residues ((xⱼ)ₘⱼ, 212, 222) of the upper residue (xⱼ) modulo the sequence of lower moduli (mᵢ), wherein at least one of the multiple lower moduli (mᵢ) does not divide a modulus of the multiple upper moduli (Mⱼ).

### FIELD OF THE INVENTION

The invention relates to an electronic calculating device, a calculating method, and a computer readable storage.

### BACKGROUND

In computing, integers may be encoded in the Residue Number System (RNS) representation. In a Residue Number System (RNS), a modulus m is a product m=m₁ . . . mₖ of relatively prime smaller moduli mᵢ, and integers y∈[0, m) are uniquely represented by their list of residues (y₁, . . . , yₖ), where yᵢ=|y|ₘ_{ᵢ} for all i; the latter notation denotes the unique integer yᵢ ∈[0, mᵢ) that satisfies y≡yᵢ mod mᵢ. As a consequence of the Chinese Remainder Theorem (CRT) for integers, the RNS representation is unique for nonnegative integers smaller than the product of the moduli, also called the dynamical range of the RNS.

An advantage of an RNS is that computations can be done component-wise, that is, in terms of the residues. By employing an RNS, computations on large integers can be performed by a number of small computations for each of the components that can be done independently and in parallel. RNS's are widely employed, for example in Digital Signal Processing (DSP), e.g. for filtering, and Fourier transforms, and in cryptography.

Especially in white-box cryptography the RNS representation is advantageous. In white-box, computations are done on encoded data, using tables that represent the result of the computations. Arithmetic on RNS represented integers can often be done separately on the RNS digits. For example, to add or multiply two integers in RNS representation it suffices to add or multiply the corresponding components modulo the corresponding moduli. The arithmetic modulo the moduli of the RNS can be done by table look-up. In white-box cryptography the table lookup may be encoded. Using an RNS to a large extent eliminates the problem of carry. Although even in white-box it is possible to correctly take carry into account, using RNS can simplify computations considerably. Moreover, the presence or absence of a carry is hard to hide and can be a side-channel through which a white-box implementation can be attacked, e.g., a white-box implementation of a cryptographic algorithm depending on a secret key, such as a block cipher, etc.

Since the dynamical range of an RNS is the product of the moduli, a large dynamical range can only be realized by increasing the number of moduli and/or by increasing the size of the moduli. This can be undesirable, especially in the case where the arithmetic is implemented by table lookup, in which case the tables become too big, or too many tables are required (or both). So, a very large dynamical range of the RNS requires either very large tables or a very large number of tables.

### SUMMARY OF THE INVENTION

An electronic calculating device arranged to calculate the product of integers is provided as defined in the claims. The device comprises a storage configured to store integers in a multi-layer residue number system representation, the multi-layer RNS representation having at least an upper layer RNS and a lower layer RNS, the upper layer RNS being a residue number system for a sequence of multiple upper moduli, the lower layer RNS being a residue number system for a sequence of multiple lower moduli, an integer being represented in the storage by a sequence of multiple upper residues modulo the sequence of upper moduli, upper residues for at least one particular upper modulus being further-represented in the storage by a sequence of multiple lower residues of the upper residue modulo the sequence of lower moduli.

The calculating device allows realizing a dynamical range that is as large as desired while employing a fixed, small set of RNS moduli, so that computations, such as additions, subtractions, multiplications, with very large integers or computations modulo a very large modulus can be done with a small set of small tables for the modular arithmetic for the RNS moduli.

In an embodiment, the upper multiplication routine is further configured to compute the product of the first (x) and second integer (y) modulo a further modulus (N). For example, in an embodiment, the calculation device computes the Montgomery product xyM⁻¹ mod N.

The calculating device is an electronic device, and may be a mobile electronic device, e.g., a mobile phone. Other examples include a set-top box, smart-card, computer, etc. The calculating device and method described herein may be applied in a wide range of practical applications. Such practical applications include: cryptography, e.g., in particular cryptography requiring arithmetic using large numbers, e.g., RSA, Diffie-Hellman, Elliptic curve cryptography etc.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 schematically shows an example of an embodiment of an electronic calculating device,

FIG. 2a schematically shows an example of an embodiment of an electronic calculating device,

FIG. 2b schematically shows an example of an embodiment of representing integers in a multi-layer RNS,

FIG. 3 schematically shows an example of an embodiment of representing integers in a multi-layer RNS,

FIG. 4 schematically shows an example of an embodiment of a calculating method,

FIG. 5a schematically shows a computer readable medium having a writable part comprising a computer program according to an embodiment,

FIG. 5b schematically shows a representation of a processor system according to an embodiment.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

Embodiments of the invention enable modular arithmetic for arbitrarily large moduli using arithmetic modulo fixed, small moduli, in particular using a fixed, small number of lookup tables. Modular multiplication is a difficult operation, but various methods, e.g., Montgomery, Barrett, Quisquater, etc., have been devised to approximate this operation, in the following sense: if r=xy mod N with 0≤r<N is the exact result of the multiplication modulo N, then these methods deliver a result z of the form z=r+qN for a small non-negative integer q. We will refer to such a result as a pseudo-residue. See, e.g., Jean-François Dehm. Design of an efficient public-key cryptographic library for RISC-based smart cards. PhD thesis, Université Catholique de Louvain, 1998, for a discussion of a number of modular arithmetic algorithms, in particular, modular multiplication, more in particular Montgomery multiplication.

We will speak of a pseudo-residue r+qN with expansion bound φ if the pseudo-residue satisfies 0≤q<φ, so remain bounded by a fixed multiple φN of the modulus N. An integer p is a pseudo-residue of the integer x modulo m if p=x mod m and 0≤p<φm, for some predetermined integer gyp. The integer φ is called the expansion bound, and limits the growth of the pseudo-residues. If φ=1, the pseudo-residue is a regular residue. It is possible, to further loosen the restriction on pseudo residues, e.g., by merely requiring that −φm<p<φm. For convenience of presentation we will not make this loosened assumption, but it is understood that the discussion below could easily be adapted to take the less restrictive bound into account. This type of pseudo-residues is termed a symmetric pseudo-residue.

In yet a further generalization, upper and lower expansion bounds may be used, e.g., by requiring that φ_{L}m<p<φ_{U}m for lower expansion factor φ_{L}, and upper expansion factor φ_{U}. The lower and upper expansion factors may be positive or negative, although φ_{L}<φ_{U}. For example, the pseudo-residue may satisfy φ_{L}≤q<φ_{U} with φ=φ_{U}−φ_{L}. Other, more complicated methods exist to compute the exact residue r, for example by doing extra subtractions of the modulus, by doing an extra multiplication or reduction, or by doing an exact division. Interestingly, modular arithmetic methods typically deliver the result as a pseudo-residue. Extra efforts are required to obtain the exact residue. For example, the Montgomery algorithm in Dehm (section 2.2.6) has as the final two steps that “if Uₙ>N then U=Uₙ−N else U=Uₙ” omitting this extra reduction step would give a modular reduction algorithm in which the output is a pseudo residue with expansion factor 2. Modular multiplication algorithms with a larger expansion factor, even as high as a few hundred may be used in the algorithm. This is not a problem, e.g., if long as conversion is only needed after a long sequence of operations within the system. In general, when referring to a residue, it may be a pseudo-residue or exact residue.

In an embodiment of the calculating device, an upper multiplication routine is configured to receive upper residues (xᵢ, yᵢ) that are smaller than a predefined expansion factor times the corresponding modulus (xᵢ, yᵢ<φ_{U} Mᵢ) and is configured to produce upper residues (zᵢ) of the product of the received upper residues (z) that are smaller than the predefined expansion factor times the corresponding modulus (zᵢ<φ_{U}Mᵢ). In addition, the upper multiplication routine may be configured to receive upper residues (xᵢ, yᵢ) that are larger or equal than a further predefined expansion factor times the corresponding modulus (xᵢ,yᵢ≥φ_{L}Mᵢ) and is configured to produce upper residues (zᵢ) of the product of the received upper residues (z) that are larger or equal than the predefined expansion factor times the corresponding modulus (zᵢ≥φ_{L}Mᵢ). In case, φ_{L}>0, we will refer to φ=φ_{U}−φ_{L} as the expansion factor.

An important observation underlying embodiments of the invention is the following. Given a method to do modular arithmetic using an RNS, we can use that method with a small RNS with moduli mᵢ, say, to implement the modular arithmetic for each of the moduli Mᵢ of a big RNS that implements the modular arithmetic for a big modulus N. In other words, we can use a method for modular arithmetic with a RNS to build a “hierarchical” RNS with two or more layers of RNS's built on top of each other. We will refer to such hierarchical RNS systems as Multi-Layer Residue Number Systems (multi-layer RNS). In this way, we can use a small RNS, with a small dynamical range, to implement a bigger RNS, with a bigger dynamical range.

We will refer to the RNS with the largest dynamic range as the first layer, or the top layer, and to the RNS with the smallest dynamic range as the lowest layer, or the bottom layer; In an embodiment, with two layers, the bottom layer would be the second layer.

In an embodiment, such a hierarchical system is built by implementing a method to do modular arithmetic using an RNS that works with pseudo-residues instead of exact residues. Provided that the pseudo-residues remain bounded, that is, provided that they have a guaranteed expansion bound; this allows constructing very efficient systems. We stress that in such a hierarchical RNS system, all the RNS in the different layers except in the bottom layer are “virtual”, in the sense that only the bottom RNS actually does the arithmetic; all (or mostly all) of the arithmetic in higher layers is delegated to the bottom RNS.

In a typical application of a multi-layer RNS, the modular arithmetic in the bottom RNS is done by lookup tables; in that case, the multi-layer RNS system can be devised in such a way that no further arithmetic is needed beyond that of the bottom level. This makes such multi-layer RNS system particularly attractive to be used in white-box applications. In addition, hardware implementations of these multi-layer RNS systems are highly parallelizable and thus offer great promise in terms of speed.

The method has been implemented to do modular exponentiation, such as required in, e.g., RSA and Diffie-Hellman, with moduli of size around 2048 bits. In a preferred embodiment of our method, we use a two-layer multi-layer RNS, employing 8-bit moduli in the bottom RNS and 66-bit moduli in the first RNS layer. The resulting system took approximately 140000 table lookups to do a 2048-bit modular multiplication; as a consequence, a modular exponentiation with a 2048-bit modulus and a 500-bit exponent can be realized on a normal laptop in less than half a second.

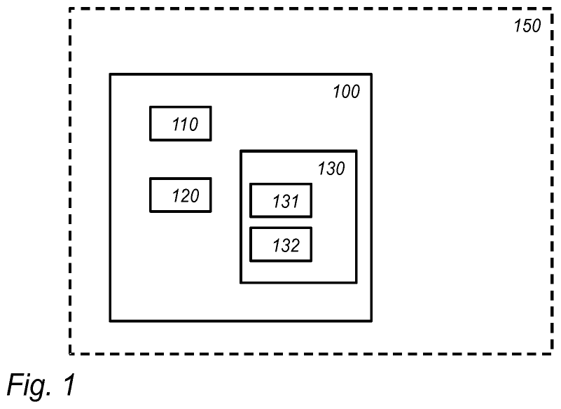

FIG. 1 schematically shows an example of an embodiment of an electronic calculating device 100.

Calculating device 100 comprises a storage 110. Storage 110 is configured to store integers in a multi-layered RNS. The multi-layered RNS has at least two layers. The first (top, upmost) layer is defined by a sequence of multiple upper moduli Mᵢ. A second (lower) layer is defined by a sequence of multiple lower moduli mᵢ. An integer in storage 110 can be represented as a sequence of upper pseudo-residues modulo the sequence of multiple upper moduli Mᵢ. At least one of the upper residues is in turn expressed as a sequence of lower residues modulo the sequence of multiple lower moduli mᵢ, e.g., it is ‘further-represented’. It is not needed that each of the upper residues is expressed in this way, but this is a possible embodiment. Note that the lower RNS can be used to express upper residues for more than one upper residue. In fact, in an embodiment the same lower RNS is used for each of the upper residues. In case each of the upper residues is expressed in the lower RNS, the integer is ultimately expressed as multiple residues modulo m₁, multiple residues modulo m₂, etc., as many as there are residues in the upper layer. In this case, the upper residues are stored in storage 110, but only in the form of sequences of lower residues. Calculating device 100 may comprise an input interface to receive the integers for storage in storage 110, and for calculating thereon. The result of a multiplication may be stored in storage 110, where it may be used as input for further computations. Integers stored in multi-layer RNS, like integers stored in singe-layer RNS can be added as well, this is not further expanded upon below.

Calculating device 100 comprises a processor circuit 120 and a further storage 130. Further storage 130 comprises computer instructions executable by processor circuit 120. Processor circuit may be implemented in a distributed fashion, e.g., as multiple sub-processor circuits. Further storage 130 comprises a lower multiplication routine 131 and an upper multiplication routine 132. In case there are more than two layers in the multi-layer RNS, there may also be multiple multiplication routines, e.g., a first layer multiplication routine, a second layer multiplication routine, a third layer multiplication routine, and so on. Note that the multiplication routines may perform additional functionality, e.g., other modular operations, e.g., modular addition etc.

Lower multiplication routine 131 is configured to compute the product of two integers that are represented in the lower RNS. In particular, lower multiplication routine 131 may be used to multiply two further-represented upper pseudo residues (xⱼ, yⱼ) corresponding to the same upper modulus (Mⱼ) modulo said upper modulus (Mⱼ). Note that the lower multiplication routine 131 produces the result modulo the upper modulus (Mⱼ) that is appropriate. Moreover, the result of the modulo operation is a pseudo residue that satisfies an expansion bound. The expansion bound may be small, say 2, or even 1, or may be larger, say a few hundred, but it allows the system to stay in RNS representation.

Upper multiplication routine 132 is configured to compute the product of a first integer x and second integer y represented in the upper layer by component-wise multiplication of upper residues of the first integer (xᵢ) and corresponding upper residues of the second integer (yᵢ) modulo the corresponding modulus (Mᵢ), wherein the upper multiplication routine calls upon the lower multiplication routine to multiply the upper residues that are further-represented. Note that the dynamic rang of the upper layer RNS is determined by the upper moduli Mᵢ, whereas that of the lower layer RNS is determined by the lower moduli mᵢ. Thus, lower moduli may be used multiple times to build a larger dynamic range. Note that normally, in a single-layer RNS this would not work. Repeating a modulus would not increase the dynamic range at all.

Typically, the upper and lower moduli are chosen relatively prime. The inventors have realized however, that this condition, although convenient, is not strictly necessary. A multi-layer RNS would also work if the moduli are not all chosen to be relatively prime, in this case, one may take the dynamic range of the lower layer as the least common multiple of the moduli m₁, . . . , mₖ, and the dynamic range of the upper layer as the least common multiple of the moduli M₁, . . . , Mₖ. In an embodiment, at least two of the upper or at least two of the lower moduli have a greatest common divisor larger than 1. This may be helpful as an additional source of obfuscation. See, e.g., “The General Chinese Remainder Theorem”, by Oystein Ore (included herein by reference).

Typically, the calculating device 100 will not be a stand-alone device, but will be used as part of a larger calculating device 150, that uses calculating device 100 to perform modular arithmetic. For example, larger device 150 may comprise calculating device 100. For example, a larger device 150 may compute modular exponents, e.g. for cryptographic purposes, etc.

Further details on various embodiments how processor circuit 120 may be configured to multiply two integers or on their representation in storage are explained below.

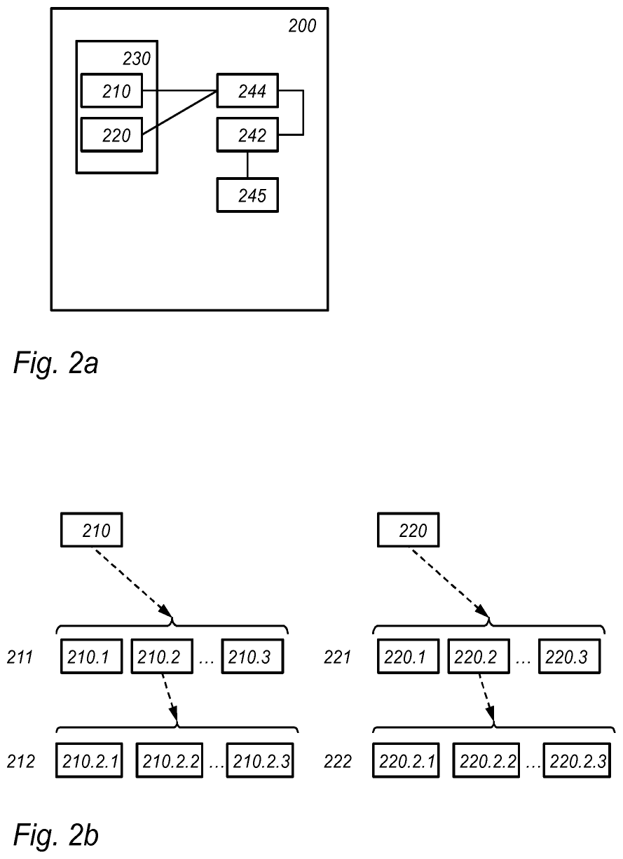

FIG. 2a schematically shows an example of an embodiment of an electronic calculating device 200. Embodiments according to FIG. 2b may be implemented in a number of ways, including hardware of the type illustrated with FIG. 1.

Calculating device 200 comprises a storage 230. Storage 230 stores integers in the form of the multi-layer RNS system. Shown are integers 210 and 220; more integers are possible. FIG. 2b illustrates the form integers 210 and 220 may have.

As shown in FIG. 2b, integer 210 is represented a sequence of multiple upper residues 211 modulo a sequence of multiple upper moduli. If the integer is x, the upper moduli are Mᵢ, then the sequence of residues may be xᵢ= [symbol] x [symbol] _{M}_{ᵢ}. The notation [symbol] x [symbol] _{M}_{ᵢ} denotes a pseudo-residue modulo the modulus Mᵢ. The pseudo-residue may be larger than Mᵢ but satisfies an expansion bound, e.g., it is smaller than φMᵢ for some expansion factor φ. In an embodiment, there is a single fixed expansion factor per layer. However, it is possible to have a different expansion factor per modulus, per layer.

Shown in FIG. 2b are three upper residues corresponding to three upper moduli. Two or more moduli is possible. For example, upper residue 210.1 may be x₁= [symbol] x [symbol] _{M}_{ᵢ}, upper residue 210.2 may be x₂= [symbol] x [symbol] _{M}_{₂}, etc. At least one of the upper residues is further-represented in the storage by data representing a sequence of multiple lower residues ( [symbol] xⱼ [symbol] ₘ_{ᵢ}; 212, 222) of the upper residue (xⱼ) modulo the sequence of lower moduli (mᵢ).

Shown in FIG. 2b are three lower residues corresponding to three lower moduli. Two or more lower moduli is possible; there is no need for the number of upper and lower moduli to be equal. For example, upper residue 210.2, e.g. x₂= [symbol] x [symbol] _{M}_{₂}, may be further-represented in the storage by a sequence 212 of multiple lower residues [symbol] xⱼ [symbol] ₘ_{ᵢ}, assuming that the modulus with index j is further-represented.

For example, lower residue 210.2.1 may be [symbol] x₂ [symbol] ₘ_{₁}, and lower residue 210.2.2 may be [symbol] x₂ [symbol] ₘ_{₂}, etc.

It is important to note that none of the upper moduli Mᵢ needs to be a product of lower moduli mᵢ. In particular, in an embodiment, the further represented modulus Mⱼ is both larger than each of the lower moduli, and not a product of any one of them. In yet a further embodiment, no upper modulus is a product of lower moduli, with the possible exception of the redundant modulus or moduli (if these are used).

If upper residue 210.2 is the only upper residue that is further represented, then storage 230 may store upper residues 210.1, 210.3, and the lower residues 210.2.1, 210.2.2 and 210.2.3. Note that upper residue 210.2 is stored but in the form of a sequence of lower residues. In an embodiment, all of the upper residues are stored as a sequence of lower residues. In other words, the number 210 is represented in a first RNS form 211 with a first set of moduli Mᵢ, each of these residues is represented in a second RNS form 212 with a second set of moduli mᵢ. The moduli of the second RNS may be the same for each of the upper residues. Although this is not necessary, it significantly reduces the complexity of the system and the number of tables. Note that each of these residues may be pseudo-residues. Furthermore, the residues may be represented in a form suitable for Montgomery multiplication, e.g., multiplied with a Montgomery constant. The residues may also be encoded.

The second integer 220 may be represented in the same form as first integer 210. Shown a sequence of multiple upper residues 221, of which upper residues 220.1-220.3 are shown. At least one of the upper residues, in this case upper residues 220.2 is further represented as a sequence of multiple lower residues 222, of which lower residue 220.2.1-220.2.3 are shown.

Returning to FIG. 2a, calculating device 200 further comprises an upper multiplication routine 244 and a lower multiplication routine 242. Lower multiplication routine 242 is configured to multiply two upper residues in the lower, e.g., second RNS system. Note that in addition to multiplication, lower multiplication routine 242 may be configured with additional modular arithmetic, e.g., addition. Upper multiplication routine 244 is configured to multiply first integer 210 and second integer 220 represented in the upper RNS system. However, as the upper moduli are represented in the form of an RNS system itself, the arithmetic on these refer to the lower multiplication routine 242. The upper multiplication routine 244 may also be configured with additional arithmetic, e.g., addition.

Arithmetic in the bottom RNS may use look-up tables to perform modular arithmetic. Calculating device 200 may comprises a table storage 245 storing tables therefore. This makes the method well-suited to be used in white-box applications since it can work with small data elements only, so that all arithmetic can be done by table lookup. In an embodiment, table storage 245 comprises tables to add and to multiply for each of the lower moduli, or in case of more than two layers, the lowest (bottom) moduli.

Instead of table look up, the calculations on the lowest layer may also be performed by other means, e.g., implemented using arithmetic instructions of a processor circuit, or using an arithmetic co-processor. In an embodiment, moduli of the form 2^{m}−c with small c can be used. For example, with m=16, and c<8.

See, for more information on white-box, the paper by Chow et al “A White-Box DES Implementation for DRM Applications”. See, for more information on white-box, and in particular on encoding using states the application “Computing device configured with a table network”, published under number WO2014096117. See also, “Computing device comprising a table network”, published under number WO2014095772, for information on how to represent computer programs in white box form. There three references are included herein by reference.

In an embodiment, the system is implemented using white-box cryptography. Data is represented in encoded form, possibly together with a state. States are redundant variables so that the encoding is not unique. For example, a (possibly very large) integer y may be represented by its list of pseudo residues (y₁, . . . , yₖ), in encoded form (in particular the lower residues). That is, every residue yᵢ is given in the form y̅ᵢ=E(yᵢ,sᵢ), were sᵢ is a state-variable and E is some encoding function (typically a permutation on the data-state space). Operations on encoded variables are typically performed using look-up tables. Larger operations are broken up into smaller operations if needed. As a result, the computation may take the form of a table network, comprising multiple look up tables. Some tables take as input part of the input to the algorithm, e.g., the number be conversed. Some tables take as input the output of one or more other tables. Some tables produce part of the output. For example, the required arithmetic modulo the mᵢ is typically implemented by some form of table look-up, at least if the m, are relatively small.

White-box prefers methods that do computations with relatively small (encoded) data. In the invention, this works particular well, since due to the multi layers the residues on which computations are done can be kept small. For example, the encoded data may be about byte size.

The inventors found that the system is improved if the tables to compute at the lowest level, e.g., addition and multiplication, are the same size, even for different lower moduli. This avoids the use of conversion tables. For example, we implement for each small modulus (e.g. 8-bit at most) the addition- and multiplication tables on numbers of byte-size, instead of just for the proper residues. Furthermore, if tables have the same size, the size of a table does not reveal the size of the lower moduli.

Furthermore, suppose that m=max mᵢ is the maximum size of the moduli mᵢ, and the lookup table for m, has entries of size T₁, with outputs of size smaller than mᵢ, say. The maximum size of a residue coming out of any of the tables is m−1, so as long as Tᵢ>=m for all I we can use outputs from one table as entries for another table. Most efficient is Tᵢ=m for all i. In an embodiment, the size of the lookup tables for the modular arithmetic operations are extended to at least accommodate entries of the size of the largest lower modulus.

Creating tables for table storage 245 may be done by selecting an arithmetic operation, say ƒ(x₁,x₂) in case of two inputs, and computing the function for all possible operands, in the example over all values of x₁ and x₂ and listing the results in a table. In case the table is to be encoded, an enumeration of E_{ƒ}(ƒ(E₁⁻¹(x₁),E₂⁻¹x₂)); in this formula, the function E₁, E₂, E_{ƒ} are the encodings of the two inputs, and of the output respectively.

Further detail of various possible embodiments of the first and second multiplication routine are given below.

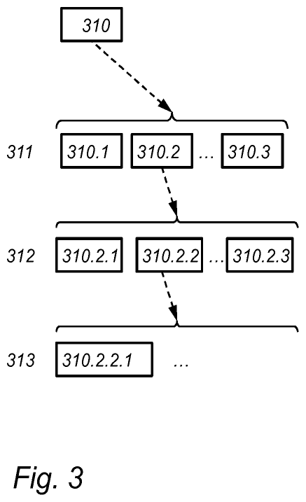

The multi-layer RNS representation may be extended to three or more layers, this is shown in FIG. 3. FIG. 3 shows an integer 310, e.g. as stored in storage 230. The integer is represented by a sequence of multiple first layer residues 311 of integer 310 modulo a first sequence of moduli. Of first sequence 311 three residues are shown: first layer residue 310.1, 310.2, and 310.3.

At least one, of the first layer residues, in the illustration residue 310.2, is represented as a sequence of multiple second layer residues 312, of the first layer residue, in this case residue 310.2. Second layer sequence 312 comprises the first layer residue modulo a second sequence of moduli. Of second sequence 312, three residues are shown: second layer residue 310.2.1, 310.2.2, and 310.2.3.

At least one, of the second layer residues, in the illustration residue 310.2.2, is represented as a sequence of multiple third layer residues 312, of the second layer residue, in this case residue 310.2.2. Third layer sequence 313 comprises the second layer residue modulo a third sequence of moduli. Of third sequence 313, three residues are shown: third layer residue 310.2.2.1, 310.2.2.2, and 310.2.2.3.

The upshot is that integer 310 is at least partly represented by residues modulo a third sequence of residues. The sizes of the moduli in the third sequence can be much smaller than the sizes of the moduli in the second sequence, and much yet than those in the first sequence.

If all of the first layer residues are represented as third layer residues, this representation makes it possible to compute with integers represented like integer 310 while only computing with small moduli.

The three hierarchical layers, shown in the multi-layer RNS of FIG. 3 can be extended to more layers. For example, it is possible to regard the second and third layers as a multi-layer RNS, e.g., as shown in FIG. 2b, to which a hierarchical higher layer 311 is added.

In an embodiment, modular arithmetic is implemented on the upper level, and as a consequence no overflow problems are suffered. If no modular arithmetic is implemented for most of the moduli, the representation system may suffer from overflow problems. Multi-layered RNS systems as described herein should not be confused with so-called two-level systems, which in fact do not have two levels of RNS, but use pairs of related moduli, typically of the form 2ⁿ±1, or even 2ⁿ±a with a small. In these cases, larger moduli are formed as the product of moduli on the lower level and, as a consequence, there is actually just one RNS.

An advantage of the Montgomery multiplication algorithm in RNS that we propose below is that it employs pseudo-residues and postponed Montgomery reduction to increase efficiency of the calculations.

Residue Number Systems are very widely employed, for example in various digital signal processing algorithms and in cryptography. A difficulty is that in order to realize a very large dynamical range of the RNS, either very many or very big moduli are required. Modular arithmetic for big moduli quickly becomes difficult to implement directly. On the other hand, there simply are not enough small moduli to realize a very large dynamical range. For example, the largest dynamical range provided with moduli of size at most 256 is at most (2⁸)⁵⁴, a 432-bit number, obtained by taking 54 prime powers of the 54 distinct primes below 256; in fact, the size can be at most 2³⁶³. Any larger dynamical range is simply not possible. Also, if the modular arithmetic is implemented by lookup tables, a dynamical range of the maximal size would require quite a large number of tables. In contrast, embodiments allow for example to realize any dynamical range up to a value slightly larger than 2048 bits while using only 18 moduli of size at most 256. The method also allows for heavy parallelization. The method, when well designed, does not suffer from overflow problems and can be applied as often as desired, for example for a modular exponentiation.

Interesting aspects of various embodiments include the following:

The idea that we can use a generic method to do modular arithmetic using an RNS to build two or more RNS's on top of each other, thus enlarging the dynamical range of the bottom RNS to that of the top RNS. In an embodiment, a system of layered RNS's is provided, where each residue or pseudo-residue value is contained in the dynamical range of the RNS below, and is represented by the RNS below. Furthermore, modular arithmetic for these pseudo-residues is implemented, in such a way that at all times the dynamical range of the representing RNS on the level below is respected. More than two layers are possible, e.g., three or more layers. In an embodiment, each layer contains residues for at least two moduli. In an embodiment, at least one modulus of the first layer is relatively prime to a modulus in the second layer, e.g., at least one modulus on each non-bottom layer is relatively prime to a modulus of the RNS of the level below. In an embodiment, the RNS in successive layers have increasing dynamical ranges, e.g., the first layer has a larger dynamic range than the second and so on.

The idea that it is sufficient to have a method for modular arithmetic employing RNS's, and doing only addition and multiplication in the RNS moduli, delivering results in the form of pseudo-residues instead of exact residues, provided that the pseudo-residues remain bounded (that is, that there is a known expansion bound). This in combination with the derivation of precise expressions for the various expansion bounds. Many modular algorithms using a RNS can be adapted to work with pseudo-residues.

The use of base extension with a redundant modulus using pseudo-residues, and of using Montgomery reduction combined with postponed modular reduction on the higher level RNS's, in combination with precise expressions for certain expansion bounds.

The idea to do an “approximate” division-and-round-down operation for suitable divisors entirely within an RNS and working with pseudo-residues.

The use of fixed-size lookup tables for the modular arithmetic on the bottom level (i.e., the use of 2⁸×2⁸ lookup tables when all small moduli are of size at most 2⁸), to make base extension on higher levels more efficient.

The use of redundant moduli on higher levels that are each a product of one or more of the moduli on the bottom level, so that exact modular arithmetic is possible for these moduli.

The use of special representations of integers x, of the form [symbol] Hⱼxⱼ [symbol] _{M-j} with fixed constants Hⱼ depending only on the modulus, for pseudo-residues [symbol] xⱼ [symbol] _{M}_{ⱼ}, in order to simplify the algorithm. This improvement generalizes on Montgomery representations. For example, Hₛ=|1/m|Mₛ gives Montgomery representation. It gains about 20% of the operations. It is possible, to make valid embodiments without this improvement, e.g., wherein all residues are in Montgomery representation.

Below several embodiments of the invention are disclosed, including with different underlying modular multiplication methods. At present, the preferred embodiment is based on Montgomery multiplication. We show how to implement the modular multiplication, which is the difficult operation (addition and subtraction will be discussed separately) in RNS. The system allows multiple layers, so we will describe how to add a new RNS layer on top of an existing one. Here, the bottom layer can simply be taken as an RNS with moduli mᵢ for which the required modular arithmetic is implemented, for example, by table lookup, by some direct method, or by any other method.

The top layer on which to build a new RNS will consist of an RNS with (relatively prime) moduli Mᵢ, and this top layer will meet the following bounded expansion requirement: There are positive integers m and φᵢ with the following properties. Given integers 0≤x,y<φᵢMᵢ, we can compute a pseudo-residue z with expansion bound φᵢ (so with z<φᵢMᵢ) that represents the modular product |xy|_{M}_{ᵢ}, that is, for which mz≡xy mod Mᵢ. We will write z=x⊗_{(M}_{ᵢ}_{,m)}y to denote such an integer. Thus, for every Mᵢ, there will be some means of computing a pseudo-residue representing a modular product and satisfying a given expansion bound, provided that both operands are pseudo-residues satisfying the same expansion bound.

Note that we might weaken the above requirement to the requirement that, given integers x,y with −φᵢ⁽⁰⁾ Mᵢ<x,y<φᵢ⁽¹⁾Mᵢ, we can compute a pseudo-residue z=x⊗_{(M}_{ᵢ}_{,m)}y with mz≡xy mod Mᵢ and −φᵢ⁽⁰⁾ Mᵢ<z<φᵢ⁽¹⁾Mᵢ. The point here is that we need to have some constraint so that if the constraint is satisfied by x, y, then it is also satisfied by the pseudo-residue z that represents the result of the modular multiplication |xy|_{M}_{ᵢ}.

To implement a multi-layer RNS, we could take as the first layer an RNS formed by a number of moduli mᵢ for which we can directly implement the required modular arithmetic, for example by table lookup. In such a system, all expansion bounds φᵢ are equal to 1. In an embodiment, the expansion bound for the lowest layer of the RNS equals 1, but the expansion bound for higher layers, the expansion bound is larger than 1. The method now describes how to add a new modulus N as one of the moduli of the new RNS layer to be added. Thus, the multi-layer system is built up from the lowest layer to higher layers.

The modular multiplication in the upper layer may be done with various methods. For example, in a first method the modular multiplication may be based on integer division with rounding down within the RNS, employing only modular addition/subtraction and modular multiplication for the RNS moduli, e.g., as in Hitz-Kaltofen. This method can then be employed to do modular reduction

$$h ← \vert h {\vert}_{N} = h - ⌊ \frac{h}{N} ⌋ N ,$$

and hence also modular multiplication entirely within an RNS. We briefly describe the idea. The method uses an extended RNS consisting of K+L moduli Mᵢ, grouped into a base RNS M₁, . . . , M_{K} and an extension M_{K+1}, . . . , M_{K+L}We write M=Mᵢ . . . M_{K} and M̅=M_{K+1} . . . M_{K+L} to denote the dynamical ranges of the base RNS and the extension, respectively. We will use M<M̅. Given an integer h and a modulus N, with 0≤h, N<M, first employ an iterative Newton algorithm to compute

$$R = ⌊ \frac{M}{N} ⌋ ;$$

then given R, compute

$$Q = ⌊ \frac{hR}{M} ⌋ ;$$

then one of Q or Q+1 equals

$$⌊ \frac{h}{N} ⌋ .$$

The iterative Newton algorithm takes z₀=0, z₁=2, and then

$${z}_{i + 1} = ⌊ \frac{{z}_{i} ( 2 M - {Nz}_{i} )}{M} ⌋$$

until zᵢ=zᵢ₋₁. It can be shown that this algorithm always halts, with either zᵢ or zᵢ+1 equal to

$$⌊ \frac{M}{N} ⌋ .$$

The basic step is to compute

$$⌊ \frac{u}{M} ⌋ ,$$

where u=zᵢ(2M−zᵢN) or u=hR. For example, we may use that uᵢ=|u|_{M}_{ᵢ} is maintained for all of the RNS moduli M₁, . . . , M_{K+L}. The number r=|u|_{M}<M is represented by the basic residues uᵢ for 1≤i≤K. The Mixed Radix representation

r=r₀+r₁M₁+ . . . +r_{K-1}M₁. . . M_{K-1}

with 0≤rᵢ₋₁<Mᵢ for 1≤i≤K may then be obtained from modular calculations modulo the Mᵢ. Once this representation is obtained, we can do base extension: we can obtain the missing residues in the extended RNS by letting

$${{{r}_{K + j} = \vert {\sum }_{i = 1}^{L} \vert {r}_{i - 1} {\vert}_{{M}_{K + j}} \vert {M}_{1} … {M}_{i - 1} \vert}_{{M}_{K + j}} \vert}_{{M}_{K + j}}$$

for j=1, . . . , L. Now to compute

$$Q = ⌊ \frac{u}{M} ⌋ ,$$

we first compute the full representation of r=|u|_{M} from the basis residues uᵢ with 1≤i≤K by computing the MR representation followed by a base extension. Then we compute the representation of the division Q=(u−r)M⁻¹ in the extended moduli M_{K+1}, . . . , m_{K+L}, which is possible since M has an inverse modulo the m_{K+j} and M<M̅. Finally, by a second base extension, now from the extended residues, we compute the full representation of Q. For example, we can indeed compute

$$Q = ⌊ \frac{h}{N} ⌋ ,$$

and hence the modular reduction

$$\vert h {\vert}_{N} = h - ⌊ \frac{h}{N} ⌋ N ,$$

in the RN S with moduli M₁, . . . , M_{K+L} using only modular additions, modular multiplications by precomputed constants, and modular multiplications modulo the RNS moduli Mᵢ. So, provided that N²<M, we can compute the residue |xy|_{K} from h<N² entirely within the RNS.

This first method to do modular arithmetic as sketched above can be used to build a layered RNS system. Indeed, to build a new RNS layer on top of a layered RNS system, with top layer an extended RNS with moduli Mᵢ, m_{k+z} as above, we construct a new extended RNS with moduli M₁, . . . , M_{K}, M_{K+1}, . . . , M_{K+L} that each satisfy Mᵢ²<m=m₁ . . . mₖ. Now we can implement the modular arithmetic for each of the M₁ as needed in the RNS formed by M₁, . . . M_{K+L} in terms of modular additions and multiplications modulo the mᵢ. That is, we can delegate the modular arithmetic modulo each of the Mᵢ to the layer below. The resulting system as disclosed above works entirely with exact residues, although we found that it is possible to build a more efficient system that works with pseudo-residues instead. Since this method as described here works with exact residues, we have an expansion bound φ=1.

For example, in a second method the modular multiplication may be based on Montgomery multiplication and involves the modulus N and a Montgomery constant M (it is assumed that gcd(N, M)=1). The operands X, Y and the result Z≡XY mod N of the modular multiplication Z≡XY mod N are in Montgomery representation, that is, represented by numbers x≡XM, y≡YM,z≡ZM mod N, so that xy≡zM mod N. In terms of the Montgomery representations, we want to find an integer solution z, u of the equation

h+uN=Mz,

where h=xy is the ordinary (integer) product of x and y. The conventional form of the (single-digit) Montgomery multiplication method is the following. Pre-compute the constant N̅=|(−N)⁻¹|_{M}; then do

1. h=xy;

2. u=|hN̅|_{M};

3. z=(h+uN)/M.

Since h+uN≡0 mod M, the division in step 3 is exact; moreover, for the result Z we have Mz≡h≡xy mod N; moreover, if x, y are in fact pseudo-residues with expansion bound φ, then 0≤xy<φN, hence

$$\begin{matrix}0 \leq z = ( xy + uN ) \text{/} M < ( {ϕ}^{2} {N}^{2} + MN ) \text{/} M = ( {ϕ}^{2} \frac{N}{M} + 1 ) N . & ( 1 ) \\ If & \\ {ϕ}^{2} \frac{N}{M} + 1 \leq ϕ , & \end{matrix}$$

then the result z again meets the expansion bound 0≤z<φN. For example, to have φ=2, it is sufficient to require that M≥4N. More general, putting φ=1/ε with 0<ε<1, the final result again meets the expansion bound φ provided that the modulus satisfies

N≤ε(1−ε)M.

There are various possible methods to adapt this algorithm for an implementation in a RNS. The computation of N in RNS is straightforward, e.g. it may be precomputed or otherwise. Interestingly, also a representation of u in the right RNS is obtained. For example, u=hN̅ mod M would determine u but only gives the residues of u in the left RNS. Note that the z in step 3 may use division by M, so it can be computed directly only in the right RNS. However, by using base extension, either for u, or for z the rest may also be computed. We found that the latter choice worked slightly better.

A better method seems to use an extended RNS consisting of K+L moduli Mᵢ, grouped into a base or left RNS M₁, . . . , M_{K}, with dynamical range M=M₁ . . . M_{K}, and an extension or right RNS M_{K+1}, . . . , M_{K+L}, with dynamical range M′=M_{K+1} . . . M_{K+L}. These left and right RNS should not be confused with the layers of the multi-layer RNS, but are two parts of the same layer. For example, the following method may be used from Jean-Claude Bajard, Sylvain Duquesne, Milos Ercegovac, Nicolas Meloni. Residue systems efficiency for modular products summation: Application to Elliptic Curves Cryptography. Proceedings of SPIE: Advanced Signal Processing Algorithms, Architectures, and Implementations. XVI, August 2006, 6313, 2006

The Montgomery constant M may be taken as the product of the left moduli. Moreover, we will use an additional, redundant modulus M₀ in order to do base-extension. Note that we use these methods with pseudo-residues instead of with exact residues. Note, in particular the base extension for z instead of for u, and the novel postponed addition/multiplication steps 2 and 5 in the method below.

Our method consists of finding a suitable solution (u, z) of the equation

h+uN=zM (2)

with h=xy. We will write z=R_{(N,M)}(h) to denote the solution found by our algorithm, and we will refer to this solution as a Montgomery reduction of h. Note that Montgomery reduction provides an approximation to an integer division by the Montgomery constant M, therefore provides a means to reduce the size of a number. The idea of the algorithm is the following. We can use equation (2) to compute a suitable u such that u≡h(−N)⁻¹ mod Mᵢ for left moduli Mᵢ. A possible solution is to take u=Σᵢ₌₁^{K}μᵢ(M/Mᵢ) with μᵢ= [symbol] (h|−N⁻¹(M/Mᵢ)⁻¹|_{M}_{ᵢ} [symbol] _{M}_{ᵢ} for all i≤K. This is not necessarily the smallest possible u but it surely satisfies h+uN≡0 mod M. Then we can compute pseudo-residues zⱼ= [symbol] (hⱼ+uN)M⁻¹ [symbol] )_{M}_{ⱼ} for right and redundant moduli Mⱼ. Finally, we can do base extension to compute the residues of z modulo the left moduli Mᵢ: writing z=Σ_{j=K+1}^{K+L}ηⱼ(M′/Mⱼ)−qM′ with ηⱼ= [symbol] zⱼ|(M′/Mⱼ)⁻¹|_{M}_{ⱼ} [symbol] _{M}_{ⱼ}, we can first use the redundant residues to compute q exactly, and then we can use this expression for z to determine pseudo-residues of z modulo the base moduli Mᵢ.

We now turn to the details of an embodiment of this method. We begin by listing the setup, inputs and result for the method. We use the following.

1. Given are a modulus N, an extended RNS with base (left) RNS formed by base moduli M₁, . . . , M_{K} and extension (right) RNS formed by M_{K+1}, . . . , M_{K+L} with dynamical ranges M=M₁ . . . M_{K} and M′=M_{K+1} . . . M_{K+L}, and a redundant modulus M₀. Preferably, all moduli are relatively prime in pairs except possible for (M₀, N). As noted above, it is not strictly necessary thought that all moduli are relatively prime, although this may lead to a smaller dynamic range.

2. An implementation of Montgomery multiplication and Montgomery reduction for the moduli of the extended RNS such that
if eᵢ=aᵢ ⊗_{(M}_{ᵢ}_{,m)}bᵢ with 0≤aᵢ,bᵢ<φ₁Mᵢ, then eᵢ is a pseudo-residue modulo Mᵢ for which meᵢ≡aᵢbᵢ mod Mᵢ and 0≤eᵢ<φ₁Mᵢ, for all i.
if eᵢ=aᵢ ⊗_{(M}_{ᵢ}_{,m)} Cᵢ with 0≤aᵢ<φ₁Mᵢ and 0≤Cᵢ<Mᵢ, then 0≤eᵢ<ϕ₁Mᵢ, for all i (a possibly sharper expansion bound holds for multiplication moduli Mᵢ by a true residue, for example a constant).
If zᵢ=R_{(M}_{ᵢ}_{,m)}(hᵢ) is the computed Montgomery reduction of hᵢ, then z, is a pseudo-residue for which mzᵢ≡hᵢ mod Mᵢ and 0≤zᵢ<φ₁Mᵢ, provided that 0≤hᵢ<φ₁²Mᵢ².
Modular arithmetic for the redundant modulus is exact, that is, all pseudo-residues modulo M₀ are in fact true residues.

So we implement the modular arithmetic modulo the Mᵢ with expansion bound φ₁, and expansion bound ϕ₁ for multiplication by a constant. For the redundant modulus, we require expansion bound equal to 1. In fact, these expansion bounds may even depend on the modulus Mᵢ; for simplicity, we have not included that case in the description below. Here m is a constant which is the Montgomery constant for the RNS level below.

3. Input for the Montgomery multiplication algorithm are pseudo-residues x, y modulo N for which x, y<φN, represented with respect to the entire moduli set M₀, . . . , M_{K+L}, in Montgomery representation with expansion factor φ₁, except for the redundant modulus. That is, x is represented by a=(a₀, a₁, . . . , a_{K+L}) with mx≡aᵢ mod Mᵢ, and 0≤aᵢ<φ₁Mᵢ for 0≤i≤K+L and a₀≡x mod M₀; and similarly y is represented by b=(b₀, . . . , b_{K+L}) with my≡bᵢ mod Mᵢ, and 0≤bᵢ<φ₁Mᵢ for 1≤i≤K+L and b₀≡y mod M₀. We will refer to such a representation as a residue Montgomery representation.

4. The computed output of a Montgomery multiplication or reduction will be a pseudo-residue z for which 0≤z<φN, represented with respect to the entire moduli set in Montgomery representation by c=(c₀, c₁, . . . , c_{K+L}) with 0≤cᵢ<φ₁Mᵢ and mcᵢ≡z mod Mᵢ for 1≤i≤K+L and c₀ ≡z mod m₀; for the result z of a Montgomery multiplication by a constant less than N we will have z<ϕN, with possibly ϕ smaller than φ. Here, z satisfies (2), with h=xy in case of a Montgomery multiplication of x and y.

The modular arithmetic operations that are implemented are the following.

1. Integer Multiplication in RNS

Given inputs x,y as in point 3 above, we can compute the integer product h=xy, represented with respect to the entire moduli set in residue Montgomery representation e=(e₀, e₁, . . . , e_{K+L}), by computing

eᵢ=aᵢ⊗_{(M}_{ᵢ}_{,m)}bᵢ

for 0≤i≤K+L and e₀=a₀ ⊗_{(M}_{₀}_{,1)} b₀=|a₀b₀|_{M}_{₀}. In view of the above, notably in point 2, this indeed produces a residue Montgomery representation for h.

2. Montgomery Reduction

Assuming h to be represented in residue Montgomery representation as e=(e₀, e₁, . . . , e_{K+L}), the Montgomery reduction z=R_{(M,N)} (h) is computed by the following steps.

1. Compute

μᵢ=e₁⊗_{(M}_{ᵢ}_{,m)}|−N⁻¹(M/Mᵢ)⁻¹|_{M}_{ᵢ}

for the lower moduli (that is, for i=1, . . . , K). As a consequence, the integer u=Σᵢ₌₁^{K}(M/Mᵢ) satisfies v=h+uM=zN for some integer z.

2. Next, compute

$${γ}_{j} = {e}_{j} {\vert {M}^{- 1} m \vert}_{{M}_{j}} + {\sum }_{i = 1}^{K} {μ}_{i} {\vert N {M}_{i}^{- 1} {m}^{2} \vert}_{{M}_{j}}$$

(using component-wise integer addition and integer multiplication to compute the products and the sum), followed by the Montgomery reduction

cⱼ=R_{(M}_{ⱼ}_{,m)}(γⱼ)

for the extension moduli (that is, for j=K+1, . . . , K+L). For the redundant modulus, we simply compute

$${c}_{0} = {z}_{0} = \vert ( h + uN ) \text{/} M {\vert}_{{M}_{0}} = {\vert {e}_{0} {M}^{- 1} + {\sum }_{i = 1}^{K} {μ}_{i} {M}_{i}^{- 1} N \vert}_{{M}_{0}} .$$

Here, the cⱼ form the residue Montgomery representations for the extension and redundant residues of z=(h+uM)/N.

Note that for the bottom level RNS, all modular arithmetic is direct, with Montgomery constant 1; so, on the bottom level, the additions and multiplications for γⱼ would be implemented as modular operations, and no reduction would be required.

3. Now, compute

ηⱼ=cⱼ⊗_{(M}_{ⱼ}_{,m)}|(M′/Mⱼ)⁻¹|_{M}_{ⱼ}

for extension moduli (that is, for K+1≤j≤K+L).

4. Next, compute

$$q = \vert {{c}_{0} ( - {M}^{′} )}^{- 1} {m}^{- 1} + {\sum }_{j = K + 1}^{K + L} {{n}_{j} ( {M}_{j} )}^{- 1} {\vert}_{{M}_{0}} ,$$

(sum over the extension moduli), with exact modular arithmetic. Now z=Σηⱼ(M′/Mⱼ)−qM′.

5. Finally, compute

$${γ}_{i} = q {\vert - {M}^{′} {m}^{2} \vert}_{{M}_{i}} + {\sum }_{j = K + 1}^{K + L} {η}_{j} {\vert {m}^{2} ( {M}^{′} \text{/} {M}_{j} ) \vert}_{{M}_{i}}$$

(using component-wise integer addition and integer multiplication to compute the products and the sum), followed by the Montgomery reduction

cᵢ=R_{(M}_{ᵢ}_{,m)}(γᵢ)

for the lower moduli (that is, for i=1, . . . , K).

Modular Dot Products and Modular Sums with Postponed Reduction

To compute a t-term dot product sum σ=(x⁽¹⁾c⁽¹⁾+ . . . +x^{(t)}c^{(t)})_{N}, where the c⁽ⁱ⁾ are constants, we compute

h=x⁽¹⁾|c⁽¹⁾M|_{N}+ . . . +^{(t)}|c^{(t)}M|_{N},

in RNS, so by components-wise integer multiplication and addition, followed by

σ=R_{(N,M)}(h). (3)

Similarly, we can compute a t-term sum S= [symbol] x⁽¹⁾+ . . . +x^{(t)} [symbol] _{N} either by the method above taking constants c⁽ⁱ⁾=1, or by computing instead the pseudo-residue σ′=R_{(N,M)}(s)), where Mσ′≡σ mod N, while incorporating the extra factor |M⁻¹|_{N} into subsequent calculations.

Possible Bounds

Note that all the required constants in the above algorithms can be precomputed. The above method can be immediately implemented, but it will only work correctly for all possible inputs provided that a number of conditions (bounds) hold to prevent overflow and to guarantee that the final results again satisfy the specified expansion bounds.

First, we list possible requirements on the moduli. First of all, the moduli M₀ and M₁, . . . , M_{K+L} should form a RNS, so they should preferably be relatively prime in pairs. Moreover, all moduli, except possibly M₀, should be relatively prime to the modulus N. Note that if M and M′ are co-prime, then left and right moduli are co-prime, and that if M₀ is coprime with M′, then M₀ is be coprime with the right moduli; these things are desired.

Now, for Montgomery reduction z=R_{(N,M)}(h) to work for h=xy, given that 0≤x,y<φN, that is, to produce a number z with 0≤z<φN again, it is required that

$${ϕ}^{2} \frac{N}{M} + U \leq ϕ , \qquad ( 4 )$$

where UM is the maximum size of u=Σᵢ₌₁^{K}μᵢ(M/Mᵢ). If (4) holds, then Montgomery reduction z=R_{(N,M)}(h) will produce a z with 0≤z<φN whenever 0≤h<φ²N². If the μᵢ satisfy an expansion bound μᵢ<ϕ₁Mᵢ, then U=Kϕ₁. A similar condition turns up again in other multiplication algorithms, and can be solved as follows. From the inequality, we see that φ>U>0. Writing

φ=U/ε

with 0<ε<1, we conclude that we should have

N≤ε(1−ε)M/U,U=Kϕ₁,

Note that in order to maximize the size of the modulus N that we still can handle, we should choose ε=½.

If we reduce h=xC for some constant C<N, we obtain that the result z<(φN/M+U)N, that is, Montgomery multiplication by a constant has expansion bound ϕ=φN/M+U. From φ=/ε and N≤ε(1−ε)M/U, we see that we can guarantee that

ϕ≤U+1−ε<U+1=εφ+1.

The modulus h should always be representable without overflow in the RNS formed by the base, extension and redundant moduli; hence

φ²N²≤M₀MM′; (5)

moreover, in order that z is represented without overflow in the RNS formed by the extension moduli, we require that

φN≤M′.

Since N≤ε(1−ε)M/U and φ=U/ε, we conclude that φN≤(U/ε)ε(1−ε)M/U=(1−ε)M; if we combine that with φN≤M′, we find that φ²N²<(1−ε)MM′<M₀MM′, so this condition is implied by the other conditions. Since φN<(U/ε)ε(1−ε)M/U=(1−ε)M, the bound φN<M′ is certainly satisfied if

(1−ε)M≤M′.

In step 4, we have that z=Σ_{i=K+1}^{K+L}ηⱼ(M′/Mⱼ)−qM′; since 0≤z<φN≤M′ and 0≤ηⱼ<ϕ₁Mⱼ, so that Σ_{i=K+1}^{K+L}ηⱼ(M′/Mⱼ)<ϕ₁L, we conclude that 0≤q<ϕ₁L. So q is determined from its residue modulo the redundant modulus M₀ provided that

M₀≥φ₁L.

Finally, in order that the two postponed reductions in step 2 and step 5 of the algorithm work (that is, produce a small enough z), we need that γᵢ,γⱼ<φ² N². Using the bounds μᵢ<ϕ₁Mᵢ and ηⱼ<ϕ₁Mⱼ for i=1, . . . , K and j=K=1, . . . , K+L, we see that we could require

$${ϕ}_{1} {M}_{j} + {φ}_{1} {\sum }_{i = 1}^{K} {M}_{i} \leq {ϕ}_{1}^{2} {M}_{j} , {M}_{0} + {φ}_{1} {\sum }_{j = K + 1}^{K + L} {M}_{j} \leq {ϕ}_{1}^{2} {M}_{i} .$$

In order to understand these bounds, we offer the following. On a level above bottom level, all ordinary moduli are very large and about equal, and much larger than the redundant modulus. Then, writing ϕ≈U₁ and ε₁≈½, the desired value, we find that the bounds roughly state that K, L≤4U₁. For example, for a two-level system, we have U₁=k, the number of base moduli in the bottom RNS, so we approximately need that the numbers K and L of base and extension moduli in the first level, respectively, satisfy K, L≤4k. In our two-level preferred embodiment, it turns out that these bounds come for free.

In order to guarantee that the computed pseudo-residue σ satisfies the expansion bound 0≤σ<φN, we should guarantee that the number h in (3) is smaller than φ²N²; this leads to the bound

t≤φ²/θ

if the x⁽ⁱ⁾ satisfy 0≤x⁽ⁱ⁾<θN for all i. where in general θ=ϕ.

Note that the postponed reductions in steps 2 and 5 of the algorithm are (K+1)-term and (L+1)-term dot product for the moduli Mᵢ; they work under slightly less severe conditions since we have better bounds for the μᵢ and the ηⱼ.

A number of practical issues are addressed below

1. Table Sizes

Consider the algorithm above, now implemented in the bottom RNS with moduli m₀, m₁, . . . , mₖ₊ₗ, say. In step 2 and 5 of the algorithm, the numbers μᵢ (representing a residue modulo mᵢ) and ηⱼ (representing a residue modulo mⱼ) are multiplied with a constant which is a residue modulo a different modulus mₛ. On higher levels, this is no problem since both numbers are represented in RNS with respect to the moduli one level lower; however, on the lowest level, such numbers are from the range [0, mᵢ) or [0, mⱼ), respectively, and are supposed to serve as an entry in the addition or multiplication table for modulus mₛ. The resulting problem can be solved in two different ways.

1. First, for every modulus mₛ we may use a unary reduction table Rₛ that converts a number 0≤a<maxₜmₜ to its residue Rₛ(a)=|a|ₘₛ modulo mₛ. This allows having arithmetic tables of different, hence on average smaller sizes, but requires an extra table access for arithmetic operations on the lowest level, hence would make the program slower.

2. A second solution is to extend all arithmetic tables to a fixed size s=maxₛmₛ; this allows effortless arithmetic operations at the lowest level and no modular conversion needed, for increased speed and simplicity, at the cost of slightly larger tables.

In our preferred embodiment, which emphasizes speed, we have chosen the second solution.

2. The Redundant Moduli

On the bottom level, we may require m₀≥k, which allows the redundant modulus m₀ to be very small. On the next level, we may require m₀≥Kϕ₁, which requires the redundant modulus M₀ to be at least of size about L(k+1), which is typically slightly larger than the largest small modulus. Also, in step 2 of the algorithm in the previous section, we want to do this step for the redundant modulus in an easier way, by table lookup and not using Montgomery reduction. This requires that we can obtain from the “big”μᵢ (so in RNS-notation with respect to the small moduli) in an easy way the big-redundant residue. Again, the resulting problems can be solved in two ways.

1. Take m₀=m₀≥L(k+1). Then all tables must be of slightly larger size, but things are simple. Note that having extra reduction tables for all other small moduli would then help to decrease table sizes, at the expense of speed.

2. Take M₀ to be the product m′ᵣ_{₁} . . . m′ᵣ_{ₜ} with m′ᵣ_{ᵢ}|mᵣ_{ᵢ} for 1≤i≤t, (typically m′ᵣ_{ᵢ}=mᵣ_{ᵢ}), for some suitable divisors and a suitable t, where rᵢ∈{1, . . . , k+l} for all i. Then suitable residues modulo the m′ᵣ_{ᵢ} are always available from the corresponding residues modulo mᵣ_{ᵢ}, and all operations are easy, except at one place. We can represent big numbers by a list of big residues in Montgomery RNS representation with respect to the small moduli for each of the big moduli, and a final big-redundant residue in the form of a list of residues modulo the m′ᵣ_{ᵢ} (or simply modulo the mᵣ_{ᵢ}). Then in step 4 of the algorithm, we obtain q as a list of residues modulo each of the mᵣ_{ᵢ}, taking 2lr operations instead of just 2l. Note that in step 4 of the algorithm for the “big” moduli, we need the residues modulo the redundant modulus M₀ of the numbers μᵢ; these residues are immediately available if the “big” redundant modulus is product of (divisors of) moduli mᵢ on the bottom level. Now in step 5, we have available qᵢ=q mod m′ᵣ_{ᵢ}; to compute qhᵢ mod Mᵢ as (pseudo)-residue, we need qh_{i,j} mod mᵢ for all j; this is immediate for the last r small moduli, but may use some form of base extension, or an additional table, for the other small moduli.

Below an advantageous embodiment is given based on this multiplication method. In that embodiment, we have taken k=l=9, K=L=32, so that we may take m₀≥10. For the big redundant modulus, we need that M₀≥320 to ensure that in step 4 of the algorithm, the size of M₀ is at least the maximum size 320 of the value of q. Therefore, we take r=2, and hence M₀=mₖ₊ₗmₖ₊ₗ₋₁=253·233. then q=q₀ if q₀=q₁ or q₀=q₁+233, and q=q₀+253 if q₁=q₀+20. Since q₀ falls into the maximum entry-size for the multiplication tables, we can implement the multiplication by q in step 4 of the algorithm as a multiplication by q₀, possibly followed by a multiplication by 253 and an addition. In this way, the total extra costs for the entire algorithm will now be limited to the cost of an if-statement and 2K table lookups.

Pre- and post-processing, e.g., conversion to/from Montgomery form and conversion, or to/from RNS representation may be required. These are standard operations, which are not further discussed. For example, before starting computations in the Montgomery representations, the data may still have to be put into Montgomery and RNS form. form. After the computations, the data may have to be reduced to residues by subtracting a suitable multiple of the modulus. The Montgomery constant may have to be removed too, and the data may have to be reconstructed from the RNS representation, etc.

The algorithm in the previous section can be improved; in fact, we can do without one (and possibly two) of the steps in the algorithm. Here we will present the improvements. The idea is to change the way in which the residues are represented to better adapt to the base extension step. We will use the same notation and assumptions as before. For example, in an embodiment, a calculating device is presented, wherein a sequence of constants Hₛ is defined for the moduli Mₘ at least for the upper layer, so that a residue xₛ is represented as a pseudo-residue yₛ such that xₛ=Hₛyₛ mod Mₛ, wherein at least one Hₛ differs from m⁻¹ mod Mₛ. These representations are unique provided that Hₛ and Mₛ are co-prime. Hₛ may be different from the Montgomery constants used above or in the cited literature. An advantage is easy computation of h=xy, since we can find the representation of the residues hₛ of h by Montgomery multiplication of the representations of the residues xₛ and yₛ, for every s.

Our starting point is the assumption A(m, Bᵢ, φᵢ, φᵢ) that, for all moduli n co-prime to m and satisfying a bound n≤Bᵢ, we can build or construct a device that implements (in software, or in hardware) a Montgomery reduction z=R_{(n,m)} (h), a Montgomery multiplication z=x⊗_{(n,m)} y, and “weighted sums”, with expansion bound φᵢ and constant-expansion bound ϕ₁. That is, given integers x,y and h with 0≤x,y<φ₁n and 0≤h<φ₁²n² and an integer constant c with 0≤c<n, then we have algorithms to compute an integer z satisfying z≡hm⁻¹ mod n or z≡xym⁻¹ mod n with 0≤z<φᵢn and an algorithm to compute z≡cym⁻¹ mod n with 0≤z<ϕ₁n. Moreover, we assume that we can also build a device that implements for every such modulus n the computation of a “weighted sum” S=c₁x₁+ . . . +cₜxₜ for given integer constants c₁, . . . , cₜ with 0≤cᵢ<n for i=1, t and integers x₁, . . . , xₜ with 0≤xᵢ<φ₁n for all i, provided that 0≤S<φ₁²n². Alternatively, the assumption may involve for example symmetric expansion bounds, that is, assuming |x|, |y|≤φ₁n, |h|≤φ₁² and |c|≤n/2, the algorithm computes such z with |z|≤φ₁n or with |z|≤ϕ₁n, and assuming |cᵢ|≤n/2 and |xᵢ|≤φ₁n for all i, the algorithm computes such S provided that |S|<φ₁²n². Even more general, the assumption may involve two-sided bounds (that is, bounds of the type −θ_{L}n<V<θ_{R}n for pseudo-residues v). A person skilled in the art will have no problem to adapt the description below to suit these more general conditions: the method remain the same, only, for example, the precise form of the intervals containing the constants, and the necessary conditions under which the method can be guaranteed to work, need to be adapted. For simplicity, we restrict the description to the simplest form of the assumption.

We now describe our algorithm to implement (Montgomery) multiplication ⊗_{(N,M)} modulo N with Montgomery constant M and Montgomery reduction R_{(N,M)}, for suitable moduli N and Montgomery constant M, given the assumption A(m, B₁, φᵢ, ϕ₁). First, we choose a left (G)RNS M₁, . . . , Mₖ, a right (G)RNS Mₖ₊₁, . . . , Mₖ₊ₗ, and a redundant modulus M₀. (Later, we will see that k and l have to satisfy an upper bound.) Here we take the moduli such that
gcd(Mₛ, m)=1 and Mₛ≤B₁ for=1, . . . , k+l;
gcd(Mᵢ,Mⱼ)=1 for i=1, . . . , k and j=k+1, . . . , k+l;
   We will need that gcd(M₀, Mₛ)=1 for s=1, . . . , k+l. Also, M₀ needs to be large enough, e.g., M₀≥lφ₁ (for other forms of the assumption, this lower bound may have to be adapted). Moreover, we will need that the arithmetic modulo the redundant modulus M₀ can be done exact, that is, every residue modulo M₀ is contained in the interval [0, M₀) (or, another interval of size M₀). For example, the redundant modulus M₀ can be the product of smaller moduli M₀ₛ, with the arithmetic modulo these smaller moduli, and hence the arithmetic modulo M₀, being exact.

We define

M=|cm(M₁, . . . ,Mₖ);M′=κm(Mₖ₊₁, . . . ,Mₖ₊ₗ)

so that M and M′ are the dynamical ranges of the left and right GRNS, respectively. For base extension, we will rely on the existence of constants L₁, . . . , Lₖ (for the left GRNS) and Lₖ₊₁, . . . , Lₖ₊ₗ (for the right GRNS) with 0≤Lₛ<Mₛ for s=1, . . . , k+l such that for any integer v for which v≡vₛ mod mₛ for all s we have that

$$v ≡ {v}_{1} {L}_{1} \frac{M}{{M}_{1}} + … + {v}_{k} {L}_{k} \frac{M}{{M}_{k}} mod M , v ≡ {v}_{k + 1} {L}_{k + 1} \frac{{M}^{′}}{{M}_{k + 1}} + … + {v}_{k + 1} {L}_{k + 1} \frac{{M}^{′}}{{M}_{k + 1}} mod {M}^{′} . \qquad ( 1 )$$

The existence of such constants Lₛ are guaranteed by the results from the paper (Ore—The General Chinese Remainder Theorem). Note that if the left and right GRNS are in fact both RNS (that is, if the moduli are in fact co-prime), then the Lₛ are uniquely determined modulo Mₛ, with

Lᵢ≡(M/M₁)⁻¹ mod Mᵢ, Lⱼ=(M′/Mⱼ)⁻¹ mod Mⱼ

for i=1, . . . , k and j=k+1, k+l. In particular, in that case Lₛ and mₛ are co-prime. Note that this last condition cannot be guaranteed in general for a GRNS.

Next, choose ε with 0<ε<1. Let the modulus N be a positive integer satisfying gcd(N, M)=1 and N≤B, where B=ε(1−ε)M/U with U=kϕ₁; put ϕ=U/ε and ϕ=φN/M+U≈U+1−ε; ensure that φN≤M′, for example by letting M′≥(1−ε)M. (Note that if we want to maximize B, we should take ε=½; later we will see that there can be other reasons to take ε<½.) Furthermore, set δ₋=max_{i≤k<j}Mᵢ/Mⱼ, δ₊=max_{i≤k<j}Mⱼ/Mᵢ, and δ₀=max_{i≤k}M₀/Mᵢ. (Note that δ₋≈δ₊≈1 and δ₀≈0.) Then we require in addition that k≤(φ₁²−φ₁)/(ϕ₁δ₋) and l≤(φ₁²−δ₀)/(ϕ₁δ₊). (The above expressions apply for the “standard” expansion bounds; for other type of expansion bounds, they may have to be adapted.)

We claim that now assumption A(M,B,φ,ϕ) holds. The algorithms that illustrate this claim are the following. We first choose constants Hₛ (used in the representation of inputs/outputs x, y, z) and Kₛ (used in the representation of inputs h to the Montgomery reduction) for s=1, . . . , k+l; we require that Hₛ and Kₛ are co-prime with M. Set H₀=K₀=1. Furthermore, we choose (small) constants S₁, . . . , Sₖ with Sᵢ and Mᵢ coprime for all i, which we use to optimize the algorithm. For example, we can have Hₛ=Kₛ=m⁻¹ for s=1, . . . , k+l, so that all residues are in Montgomery representation, and Sᵢ=1 for i=1, . . . , k. With this choice, the method below reduces to the earlier one. However, other choices may be more advantageous, as explained below. Then, pre-compute constants
Cᵢ=|−N⁻¹KᵢLᵢSᵢ⁻¹m|_{M}_{ᵢ} (i=1, . . . , k);
D_{0,0}=|M⁻¹|_{M}_{₀}, D_{0,i}=|SᵢMᵢ⁻¹N|_{M}_{₀} (i=1, . . . , k),
D_{j,0}=|Hₖ₊ⱼM⁻¹ m²|_{M}_{ₖ₊ⱼ}, D_{j,i}=|SᵢNMᵢ⁻¹Hₖ₊ⱼ⁻¹m|_{M}_{ₖ₊ⱼ} (i=1, . . . , k), (j=1, . . . , l);
Eₛ=|Hₖ₊ₛLₖ₊ₛm|_{M}_{ₖ₊ₛ}, (s=1, . . . , l);
F₀=|(−M′)⁻¹|_{M}_{₀}, Fₛ=|Mₖ₊ₛ⁻¹|_{M}_{₀} (s=1, . . . , l);
G_{i,0}=|−M′Hᵢm|_{M}_{ᵢ}, G_{i,j}=|Lₖ₊ⱼHₖ₊ⱼ⁻¹m|_{M}_{ᵢ}(j=1, . . . , l) (i=1, . . . , k).

Now given x and y, represented as (α₀, α₁, . . . , αₖ₊ₗ) and (β₀, β₁, . . . , βₖ₊ₗ), respectively, with 0≤α₀, β₀<M₀ (or, for example, with |α₀|, |β₀|≤M₀/2) and with 0≤αₛ, βₛ<φ₁Mₛ (or, for example, with |αₛ|βₛ|<<φ₁Mₛ) for all s=1, . . . , k+l) so that x≡αₛHₛ mod Mₛ and y≡βₛHₛ mod Mₛ for s=0, 1, . . . , k+l, we compute z=x⊗_{(N,M)} y as z=R_{(N,M)}(h) with h=xy. First, we do

1. χ₀=|α₀β₀|_{M}_{₀}, χₛ=αₛ ⊗_{(M}_{ₛ}_{,m)}βₛ (s=1, . . . , k+l);

Then h=xy is represented by the χₛ for s=1, . . . , k+l with constants Kₛ=Hₛ²m, and χ₀=|h|_{M}_{₀}, that is, h≡Hₛ²mχₛ mod Mₛ for s=1, . . . , k+l.

Next, assume that h is represented by pseudo-residues χ₀, χ₁, . . . , xₖ₊ₗ with respect to constants K₁, . . . , Kₖ₊ₗ so that h≡Kₛχₛ mod Mₛ for s=1, k+l and χ₀=|h|_{M}_{₀}. To compute z=R_{(N,M)}(h), with we do the following steps.
1. μᵢ=χᵢ ⊗_{(M}_{ᵢ}_{,m)} Cᵢ (i=1, . . . , k);
2. ξ₀=|χ₀D_{0,0}+μ₁D_{0,1}+ . . . +μₖD_{0,k}|_{M}_{₀};
sₖ₊ⱼ=χₖ₊ⱼD_{j,0}+μ₁D_{j,1}+ . . . +μₖD_{j,k} ξₖ₊ⱼ=R_{(M}_{ₖ₊ⱼ}_{,m)}(sₖ₊ⱼ) (j=1, . . . , l);
3. ηₖ₊ⱼ=ξₖ₊ⱼ⊗_{(M}_{ₖ₊ⱼ}_{,m)} Eⱼ (j=1, . . . , l);
4. q=|ξ₀F₀+ηₖ₊₁F₁+ . . . +ηₖ₊ₗFₗ|_{M}_{₀};
5. tᵢ=qG_{i,0}+ηₖ₊₁G_{i,1}+ . . . +ηₖ₊ₗG_{i,1} ξᵢ=R_{(M}_{ᵢ}_{,m)}(tᵢ) (i=1, . . . , k).
   Now the number z represented by (ξ₀, ξ₁, . . . , ξₖ₊ₗ), that is, for which z≡ξₛHₛ mod Mₛ for s=0, 1, . . . , k+l, satisfies z=x ⊗_{(N,M)} y, with z satisfying the expansion bound provided that x, y, h satisfy the required expansion bounds.

Remark 1.1 Note that if the arithmetic modulo all the mₛ is exact, then we can take Montgomery constant m=1. In that case, we can take R_{(M}_{ₛ}_{,m)}(h)=h, so that steps 3 and 6 of the above algorithm can be simplified by leaving out the Montgomery reduction step.

Remark 1.2 It may be advantageous to make certain special choices.
If we choose

Hₖ₊ₛ=|Lₖ₊ₛ⁻¹|_{M}_{ₖ₊ₛ}

for s=1, . . . , l, then Eₖ₊ₛ=m, hence ηₖ₊ₛ ≡χₖ₊ₛ mod Mₖ₊ₛ for all s=1, . . . , l; as a consequence, we may be able to skip step 4 of the above algorithm, see Remark 1.3.
Similarly, if we choose

Kᵢ=|−NSᵢLᵢ⁻¹|_{M}_{ᵢ},

then Cᵢ=m, and hence μᵢ≡χᵢ mod Mᵢ; if this holds for every i=1, . . . , k, then we may be able to skip step 2 of the above algorithm, see Remark 1.3. In the full Montgomery multiplication algorithm, we would have Kᵢ=Hᵢ²m after step 1; as a consequence, for the simplification we would need that

Hᵢ²≡−NLᵢ⁻¹Sᵢm⁻¹ mod Mᵢ.

That choice is only available if Lᵢ and Mᵢ are co-prime and if −NLᵢ⁻¹Sᵢm⁻¹ is a square modulo Mᵢ. We need Sᵢ small in order to get a good a-priory bound on u. One attractive choice is to take Mᵢ prime with Mᵢ ≡3 mod 4, so that −1 is a non-square modulo Mᵢ (such a restriction on the top-level moduli is almost for free); in that case, we can choose Sᵢ=1 or Sᵢ=1 to make −NLᵢ⁻¹Sᵢm⁻¹ a square. These last choices are extra attractive in combination with the use of symmetric expansion bounds: indeed, in that case the upper bound on u will not be influenced by the choice of the Sᵢ.
Note also that if we succeed in skipping steps 2 and 4, then the entire algorithm for z=x⊗_{(N,M)} y can be done in-place! In general, most of the algorithm can be done in-place, except that we require an extra register to store the u, distinct from xᵢ and the ηₖ₊ⱼ distinct from ξₖ₊ⱼ.

Remark 1.3 If we skip step 2 with μᵢ≡χᵢ and replace μᵢ by χᵢ in step 3, then the resulting sₖ₊ⱼ may be larger. The reason is that the μᵢ are bounded by ϕ₁Mᵢ while the χᵢ are bounded by φ₁Mᵢ. Let us consider the bounds in more detail. We have seen earlier that, writing

U=ϕ₁k,

we have that

B=ε(1−ε)M/U,φ=U/ε,ϕ≈U+1−≈U.

In an optimally designed system, we will have ε≈½, so that φ≈2ϕ. If the lower system is similarly designed, we would have that

B₁=ε₁(1−ε₁)m/U₁,φ=U₁/ε₁,ϕ₁≈U₁+1−ε₁≈U₁

for some constant U₁, with ε₁=½ in an optimally designed system. We can handle a k-term weighted sum of the μᵢ modulo some Mᵢ roughly when k≤φ₁²/ϕ₁≈ε₁⁻¹φ₁≈ε₁⁻²U₁, and we could handle a k-term weighted sum of the χᵢ modulo some Mᵢ roughly when k≤φ₁²/φ₁≈ε₁⁻¹U₁, where U₁ is independent of ε₁. We can thus increase the number of (bigger) terms that we can handle by choosing a smaller value of ε₁; for example, taking ε₁=¼ instead of ε₁=½. However, that means that the value of B₁ decreases by a factor ¾. Since log₂(3)≈1.6, we find that every modulus Mₛ in the top level will have about 0.4 bits less. For k=l≈30 as in our example, this would result in a value M that has about 12 fewer bits. So, in this way we can handle values of the modulo N that are about 12 bits smaller, or we would have to increase k by 1. We see that by fine-tuning the system on a lower level we can optimize the performance on the top level. Note that on the top level, we must replace the bound U=ϕ₁k by U=φ₁k, which also lowers the upper bound B, but only by approximately a factor 2 if ε≈½.

A similar remark applies when we want to skip step 4 by replacing ηⱼ by ξⱼ in steps 5 and 6. Indeed both replacements require similar measures.

Note that when implementing a Montgomery multiplication by a constant, then χₖ₊ⱼ and ηₖ₊ⱼ will be both upper bounded by the same bound ϕ₁Mₖ₊ⱼ; in that case, the improvement can be done without further adaptations. A similar remark applies to the possible improvement in the first part of the method.

To complete the method, we will describe how to implement weighted sum S=c⁽¹⁾x⁽¹⁾+ . . . +c⁽¹⁾x^{(t)} when 0≤S<φ²N² and 0≤c⁽ⁱ⁾<N and 0≤x⁽ⁱ⁾<φN for all i. Our bounds are such that numbers h=xy can be represented in the full GRNS, that is, we have that φ²N²≤MM′. As a consequence, the weighted sum S can also be represented in the full GRNS. Therefore, it is sufficient to compute (a representation of) the residues of s in the full GRNS, that is, to compute

Sₛ≡Kₛ⁻¹(cₛ⁽¹⁾xₛ⁽¹⁾+ . . . +cₛ^{(t)}xₛ^{(t)})mod Mₛ

for certain constants Kₛ, for every s. Suppose that the residues xₛ^{(r)} are represented by pseudo-residues αₛ^{(r)} for which xₛ^{(r)}≡Hₛαₛ^{(r)}, for every s. Then we should compute sₛ ≡dₛ⁽¹⁾xₛ⁽¹⁾+ . . . +dₛ^{(t)}xₛ^{(t)} mod Mₛ with dₛ⁽ⁱ⁾=|Kₛ⁻¹Hₛc⁽ⁱ⁾|_{M}_{ₛ} for all i. One method to do this computation is to set eₛ=|Kₛ⁻¹Hₛc⁽ⁱ⁾m|_{M}_{ₛ}, then compute Tₛ=eₛ⁽¹⁾xⱼ⁽¹⁾+ . . . +eₛ^{(t)}xₛ^{(t)}, so that Sₛ=R_{(M}_{ₛ}_{,m)}(Tₛ) for all s. By our assumptions A(m,B₁,φ₁,ϕ₁), this works as long as we can guarantee that Tₛ≤φ₁²Mₛ² for all s. On the other hand, if we cannot guarantee that the upper bound on Tₛ holds, then we can use constants eₛ=|Kₛ⁻¹Hₛc⁽ⁱ⁾m²|_{M}_{ₛ}, and compute Tₛ in the form Tₛ=R_{(M}_{ₛ}_{,m)}(ΣⱼT_{s,j}), where each T_{s,j} is of the form T_{s,j}=R_{(M}_{ₛ}_{,m)}(Σ_{i∈I}_{ⱼ}eₛ⁽ⁱ⁾xₛ⁽ⁱ⁾) (that is, we construct a “reduction tree”). A person skilled in the art will be easily able to adapt these ideas in more general forms. We remark that the method as described in the above algorithm (so with only one, postponed, reduction) will work in a two-level system, where it is enough to just require that Tₛ≤φ₁²Mₛ² for all s.

Below a third variant of modular reduction is given based on Barrett multiplication. The modular reduction |h|_{N} of an integer h may be obtained as

$$\vert h {\vert}_{N} = h - ⌊ \frac{h}{N} ⌋ N .$$

Barrett multiplication involves an operation called Barrett reduction, which tries to estimate the quotient └h/N┘. In its most general form, Barrett reduction involves two additional positive integer parameters M, M′ and is defined as

$$\begin{matrix}{B}_{( N , M , {M}^{′} )} ( h ) = h - ⌊ ⌊ \frac{h}{M} ⌋ C \text{/} {M}^{′} ⌋ N , & \\ where & \\ C = ⌊ \frac{M {M}^{′}}{N} ⌋ & \end{matrix}$$

is a constant that can be precomputed. The usefulness of Barrett reduction is based on the following observation. We have that B_{(N,M,M′)}(h)≡h mod N and |h|_{N}≤B_{(N,M,M′)}(h)≤|h|_{N}+ΔₕN, where

$${Δ}_{h} = ⌈ \frac{h}{M {M}^{′}} + ( M - 1 ) ( \frac{1}{N} - \frac{1}{M {M}^{′}} ) ⌉ .$$

Barrett reduction B_{(N,M,M′)} to do a modular multiplication can be implemented in a RNS by the following algorithm. We write c=a⊗_{(N,M,M′)} b to denote that c is a pseudo-residue obtained by an RNS implementation of the Barrett multiplication c=ab−B_{(N,M,M′)}(ab)≡ab mod N. Again, we use an extended RNS with a base RNS formed by base moduli M₁, . . . , M_{K} with dynamical range M=M₁ . . . M_{K}, and an extension RNS formed by extension moduli M_{K+1} . . . , M_{K+L} with dynamical range M′=M_{K+1} . . . M_{K+L}.

1. h=xy, done via hₛ= [symbol] xₛyₛ [symbol] _{M}_{ₛ}=xₛ⊗_{(M}_{ₛ}_{m,m′)} yₛ for s=0, . . . , K+L;

2. μᵢ= [symbol] hᵢ(M/Mᵢ)⁻¹ [symbol] _{M}_{ᵢ}, done via μᵢ=hᵢ⊗_{(M}_{ᵢ}_{,m,m′)}|(M/Mᵢ)⁻¹|_{M}_{ᵢ} for i=1, . . . , K; now u=Σᵢ₌₁^{K}μᵢ(M/Mᵢ)≤ϕKM and p=(h−u)/M is integer.

3. pⱼ= [symbol] ⱼM⁻¹+Σᵢ₌₁^{K}μᵢ|1/Mᵢ|_{M}_{ⱼ} [symbol] _{M}_{ⱼ} for j=K+1, . . . , K+L;

4. Use base extension to find the pᵢ for i=1, . . . , K;

5. ηⱼ=|pᵢC(M′/Mⱼ)⁻¹|_{M}_{ⱼ}, done via ηⱼ=pⱼ⊗_{(M}_{ⱼ}_{,m,m′)}|C(M′/Mⱼ)⁻¹|_{M}_{ⱼ} for j=0 and for j K+1, . . . , K+L;

now v=Σj=_{K+1}^{K+L}ηⱼ(M′/Mⱼ)≤Lϕ₁M′ and q=(pC−v)/M′=(C(h−u)/M−v)/M′ is integer.

6. qᵢ= [symbol] pᵢ|C/M′|_{M}_{ᵢ}+Σ_{j=K+1}^{K+L} ηⱼ|−1/Mⱼ|_{M}_{ᵢ} [symbol] ₘ, and hence for z=h−qN we have zᵢ= [symbol] hᵢ+pᵢ|(−NC)/M′|_{M}_{ᵢ}+Σ_{j=K+1}^{K+L} ηⱼ|N/Mⱼ|_{M}_{ᵢ} [symbol] _{M}_{ᵢ} for i=0, . . . , K;

7. Use base extension to find the z₁ for j=K+1, . . . , K+L.

We need a number of moduli comparable to the Montgomery algorithm, but this method will require some extra operations (two base extensions instead of one). Bounds may now be derived that have to hold to guarantee a correctly working algorithm. The same speed-ups that can be applied to the single-digit Montgomery multiplication algorithm with RNS (same-size tables, postponed reduction, suitable choice of redundant moduli) apply here, and similar techniques apply to derive the required bounds.

As fourth example, we now sketch a digit-based Montgomery multiplication algorithm with an RNS. Suppose we have an RNS M₁, . . . , M_{K} with dynamical range M=M₁ . . . M_{K} and redundant modulus M₀, with expansion factor φ₁, say. Here we may take M>>B^{s} and M_{K}=B. To compute z such that B^{s} z≡xy mod N, first write y in approximate B-ary form as

$$y = {\sum }_{i = 0}^{s - 1} {e}_{i} {B}^{i} - ɛ {B}^{s} = e - δ {B}^{s}$$

with 0≤eₜ<φ₁B and 0≤δ<φ₁ for some expansion factor φ₁. Then run the following algorithm.

1. z⁽⁻¹⁾=0;

2. For t=0, . . . s−1, set

h^{(t)}=z^{(t-1)}+xeₜ

and

z^{(t)}=R_{(N,B)}(h^{(t)})=(h^{(t)}+uₜN)/B,

where

uₜ≡h^{(t)}N̅ mod B.

3. z′=z^{(s-1)};

4. z=z′−xδ.

It is easily shown that, writing u=u₀+u₁B+ . . . +uₛ₋₁uₛ₋₁, we have B^{s} z′=xe+uN and B^{s} z=xy+uN. As we have a full RNS representation x=(x₀; x₁, . . . , x_{K}) for x, with pseudo-residues 0≤xᵢ= [symbol] x [symbol] _{M}_{ᵢ}<φ₁Mᵢ for all i=0; 1, . . . , K, and similar for y. Since M_{K}=B, we can compute the “digits” eₜ of y with the RNS and the pseudo-residues uₜ= [symbol] h^{(t)}N̅ [symbol] _{M}_{_{K}} with expansion factor φ₁. Hence u<φ₁/B^{s}, so if x,y<φN, then z′<φN again provided that

$${ϕ}^{2} \frac{N}{{B}^{s}} + {ϕ}_{1} \leq ϕ ; \qquad ( 6 )$$

setting φ=φ₁/ε we see that we need the bound

N≤ε(1−ε)B^{s}/φ₁.

Moreover, it is easily seen that in order that all intermediate results z^{(t)} satisfy an expansion bound z^{(t)}<θN, it is sufficient that

θ≥(φ+1)φ₁B/(B−1).

So as long as we have a large enough dynamical range, this method delivers a correct result within expansion factor φ.

The above should be enough to use this method to build a multi-layer RNS system.

An advantageous embodiment of the invention is a two-layer Multi-layer RNS based on the second modular multiplication method (Montgomery based) as described above, optimized for modular multiplication with 2048-bits moduli N. It can be shown that in such a system, with bottom zero-layer moduli m₀: m₁, . . . , mₖ₊ₗ with k≈l, and with top first-layer moduli M₀; M₁, . . . , M_{K+L} with K≈L, and with the arithmetic moduli the bottom moduli mᵢ implemented with table lookup for modular addition and for modular multiplication, the number of table lookups for a modular multiplication modulo N takes about 24Kk²+8K²k table lookups. Moreover, it can also be shown that with bottom moduli of size at most 2^{t} and with N of size 2^{b}, the number of table lookups is minimized by taking k≈\sqrt{b/(3t)} and K≈b/(tk), giving approximately 16\sqrt{3}/(b/t)^{3/2} table lookups. Taking b=2048 and t=8 gives k≈9 and K≈28. In our preferred embodiment, we take k=l=9 and K=L=32, which turns out slightly better than the above estimates.

For the small moduli, we take the primes
191,193,197,199,211,223,227,229,233,239,241,251,

which are the largest primes less than 256, and the composite numbers

256=2⁸,253=11·23,249=3·83,247=13·19,235=5·47,217=7·31,

which are the largest numbers of the from p¹m with m>13 prime, and which produces the largest attainable product for any list of 18 relatively prime numbers of size at most 256. Note that 255=3·5·17 is a worse choice for both 3 and 5, similarly 245=5·7² is a worse choice for both 5 and 7; the choices for 2, 11, and 13 are evidently optimal. Note that, as a consequence, the small moduli involve as prime factors all primes of size at least 191, and further the primes 2,3,5,7,11,13,19,23,31,47,83. So as redundant modulus, we can take m₀=17>k=9=l.

We take ε₁=k/(2k+1). In fact, even taking ε₁=½ works. Then the best partition of these 18 moduli such that m′≥(1−ε₁)m with m maximal turns out to take as base moduli
256,251,249,247,241,239,235,199,197

and as extension moduli
191,193,211,217,223,227,229,233,253,

with

m=2097065983013254306560, m′=1153388216560035715721.

Now the choice of the large moduli for the top layer follows. We take ε₂=½, which leads to the biggest possible upper bound for the Mₛ, so that we need to take the large moduli such that

Mₛ≤Mₘₐₓ=ε₁(1−ε₁)m/k=57669314532864493430.

We want to build a system to handle RSA moduli N having up to b=2048 bits; so, we also require that

Nₘᵢₙ=2²⁰⁴⁸−1≤ε₂(1−ε₂)M/U₁,

it turns out that we need to take K=32 lower primes below Mₘₐₓ, the smallest being
57669314532864492373

in order to have M large enough. Then to have M′≥(1−ε₂)N, we need another L=32 primes, starting with the prime
57669314532864491189.

The resulting Multi-layer RNS has been implemented in a computer program, both in Sage and in C/C++. The C++ program uses approximately 137000 table lookups for a 2048-bit modular multiplication, and takes less than 0.5 seconds on a normal 3 GHz laptop to compute 500 Montgomery multiplications.

As mentioned earlier, embodiments are very suitable to do exponentiation as required, for example, in RSA and Diffie-Hellman, also and especially in a white-box contest. Similarly, the invention can be used in Elliptic Curve Cryptography (ECC) such as Elliptic Curve Digital Signature Algorithm (ECDSA) to implement the required arithmetic modulo a very large prime p. The method is very suitable to implement leak-resistant arithmetic: We can easily change the moduli at the higher level just by changing some of the constants in the algorithm. Note that at the size of the big moduli (e.g., around 66 bits), there is a very large number of primes available for the choice of moduli. Other applications are situations where large integer arithmetic is required and a common RNS would have too many moduli or too big moduli.

In the various embodiments, the input interface may be selected from various alternatives. For example, input interface may be a network interface to a local or wide area network, e.g., the Internet, a storage interface to an internal or external data storage, a keyboard, etc.

Typically, the device 200 comprises a microprocessor (not separately shown) which executes appropriate software stored at the device 200; for example, that software may have been downloaded and/or stored in a corresponding memory, e.g., a volatile memory such as RAM or a non-volatile memory such as Flash (not separately shown). Alternatively, the device 200 may, in whole or in part, be implemented in programmable logic, e.g., as field-programmable gate array (FPGA). Device 200 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

The processor circuit may be implemented in a distributed fashion, e.g., as multiple sub-processor circuits. The storage may be an electronic memory, magnetic memory etc. Part of the storage may be non-volatile, and parts may be volatile. Part of the storage may be read-only.

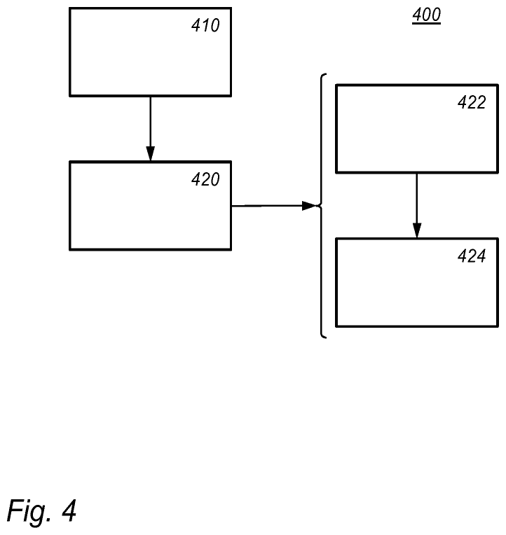

FIG. 4 schematically shows an example of an embodiment of a calculating method 400.

The method comprises a storing stage 410 in which integers are stored in multi-layer RNS format. For example, the integers may be obtained from a calculating application in which integers are manipulated, e.g., an RSA encryption or signature application, etc. The numbers may be also be converted from other formats, e.g., from a radix format into RNS format.

The method further comprises a computing stage 420 in which the product of a first integer and a second integer is computed. The computing stage comprises at least a lower multiplication part and an upper multiplication part, e.g., as described above.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method.

A method according to the invention may be executed using software, which comprises instructions for causing a processor system to perform method 400. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

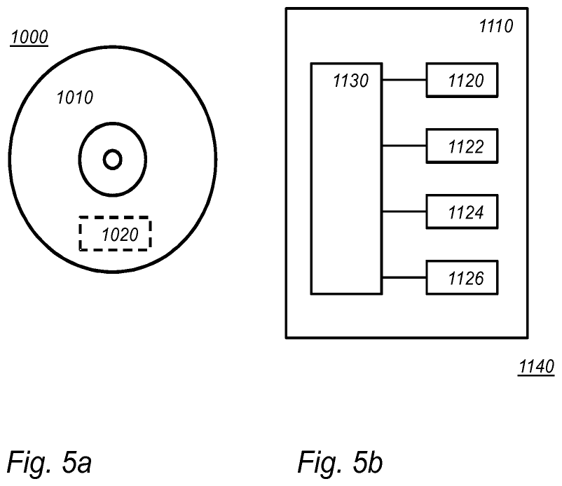

FIG. 5a shows a computer readable medium 1000 having a writable part 1010 comprising a computer program 1020, the computer program 1020 comprising instructions for causing a processor system to perform a calculating method, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said calculating method.

FIG. 5b shows in a schematic representation of a processor system 1140 according to an embodiment. The processor system comprises one or more integrated circuits 1110. The architecture of the one or more integrated circuits 1110 is schematically shown in FIG. 5b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the calculating device may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the verification device may comprise a non-volatile software interface, e.g., a hard drive, a network interface, etc., arranged for providing the software.

The following clauses are not the claims, but are contemplated and nonlimiting. The Applicant hereby gives notice that new claims may be formulated to such clauses and/or combinations of such clauses and/or features taken from the description or claims, during prosecution of the present application or of any further application derived therefrom.

Clause 1. An electronic calculating device (100; 200) arranged to calculate the product of integers, the device comprising

a storage (110) configured to store integers (210, 220) in a multi-layer residue number system (RNS) representation, the multi-layer RNS representation having at least an upper layer RNS and a lower layer RNS, the upper layer RNS being a residue number system for a sequence of multiple upper moduli (Mᵢ), the lower layer RNS being a residue number system for a sequence of multiple lower moduli (mᵢ), an integer (x) being represented in the storage by a sequence of multiple upper residues (xᵢ= [symbol] x [symbol] _{M}_{ᵢ}; 211, 221) modulo the sequence of upper moduli (Mᵢ), upper residues (xⱼ; 210.2, 220.2) for at least one particular upper modulus (Mⱼ) being further-represented in the storage by a sequence of multiple lower residues ( [symbol] xⱼ [symbol] ₘ_{ᵢ}; 212, 222) of the upper residue (xⱼ) modulo the sequence of lower moduli (mᵢ), wherein at least one of the multiple lower moduli (mᵢ) does not divide a modulus of the multiple upper moduli (Mⱼ),

a processor circuit (120) configured to compute the product of a first integer (x; 210) and a second integer (y; 220), the first and second integer being stored in the storage according to the multi-layer RNS representation, the processor being configured with at least a lower multiplication routine (131) and an upper multiplication routine (132),

the lower multiplication routine computing the product of two further-represented upper residues (xⱼ, yⱼ) corresponding to the same upper modulus (Mⱼ) modulo said upper modulus (Mⱼ),

the upper multiplication routine computing the product of the first and second integer by component-wise multiplication of upper residues of the first integer (xᵢ) and corresponding upper residues of the second integer (yᵢ) modulo the corresponding modulus (Mᵢ), wherein the upper multiplication routine calls upon the lower multiplication routine to multiply the upper residues that are further-represented.

Clause 2. An electronic calculating method (400) for calculating the product of integers, the method comprising

storing (410) integers (210, 220) in a multi-layer residue number system (RNS) representation, the multi-layer RNS representation having at least an upper layer RNS and a lower layer RNS, the upper layer RNS being a residue number system for a sequence of multiple upper moduli (Mᵢ), the lower layer RNS being a residue number system for a sequence of multiple lower moduli (mᵢ), an integer (x) being represented in the storage by a sequence of multiple upper residues (xᵢ= [symbol] x [symbol] _{M}_{ᵢ}; 211, 221) modulo the sequence of upper moduli (Mᵢ), upper residues (xⱼ; 210.2, 220.2) for at least one particular upper modulus (Mⱼ) being further-represented in the storage by a sequence of multiple lower residues ( [symbol] xⱼ [symbol] ₘ_{ᵢ}; 212, 222) of the upper residue (xⱼ) modulo the sequence of lower moduli (mᵢ), wherein at least one of the multiple lower moduli (mᵢ) does not divide a modulus of the multiple upper moduli (Mⱼ),

computing (420) the product of a first integer (x; 210) and a second integer (y; 220), the first and second integer being stored in the storage according to the multi-layer RNS representation, the computing comprising a at least a lower multiplication part (424) and an upper multiplication part (422),

the lower multiplication part computing (424) the product of two further-represented upper residues (xⱼ, yⱼ) corresponding to the same upper modulus (Mⱼ) modulo said upper modulus (Mⱼ),

the upper multiplication part computing (422) the product of the first and second integer by component-wise multiplication of upper residues of the first integer (xᵢ) and corresponding upper residues of the second integer (yᵢ) modulo the corresponding modulus (Mᵢ), wherein the upper multiplication routine calls upon the lower multiplication routine to multiply the upper residues that are further-represented.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

### LIST OF REFERENCE NUMERALS

100 an electronic calculating device
110 a storage
120 a processor circuit
130 a storage
131 a lower multiplication routine
132 an upper multiplication routine
150 a larger calculating device
200 an electronic calculating device
210, 220 an integer
210.1-210.3 an upper residue
210.2.1-210.2.3 a lower residue
220.1-220.3 an upper residue
220.2.1-220.2.3 a lower residue
211, 221 a sequence of multiple upper residues
212, 222 a sequence of multiple lower residues
230 a storage
242 a lower multiplication routine
244 an upper multiplication routine
245 a table storage
310 an integer
310.1-310.3 a first layer residue
310.2.1-310.2.3 a second layer residue
310.2.2.1 a third layer residue
311 a sequence of multiple first layer residues
312 a sequence of multiple second layer residues
313 a sequence of multiple third layer residues

1. An electronic calculating device arranged to calculate the product of integers, the device comprising
a storage configured to store integers in a multi-layer residue number system (RNS) representation, the multi-layer RNS representation having at least an upper layer RNS and a lower layer RNS, the upper layer RNS being a residue number system for a sequence of multiple upper moduli (Mᵢ), the lower layer RNS being a residue number system for a sequence of multiple lower moduli (mᵢ), an integer (x) being represented in the storage by a sequence of multiple upper residues (xᵢ= [symbol] x [symbol] _{M}_{ᵢ}) modulo the sequence of upper moduli (Mᵢ), upper residues (xⱼ) for at least one particular upper modulus (Mⱼ) being further-represented in the storage by a sequence of multiple lower residues ( [symbol] xⱼ [symbol] ₘ_{ᵢ}) of the upper residue (xⱼ) modulo the sequence of lower moduli (mᵢ), wherein at least one of the multiple lower moduli (mᵢ) does not divide a modulus of the multiple upper moduli (Mⱼ),
a processor circuit configured to compute the product of a first integer and a second integer (y), the first and second integer being stored in the storage according to the multi-layer RNS representation, the processor being configured with at least a lower multiplication routine and an upper multiplication routine,
the lower multiplication routine computing the product of two further-represented upper residues (xⱼ, yⱼ) corresponding to the same upper modulus (Mⱼ) modulo said upper modulus (Mⱼ),
the upper multiplication routine computing the product of the first and second integer by component-wise multiplication of upper residues of the first integer (xᵢ) and corresponding upper residues of the second integer (yᵢ) modulo the corresponding modulus (Mᵢ), wherein the upper multiplication routine calls upon the lower multiplication routine to multiply the upper residues that are further-represented, wherein the upper multiplication routine is configured to receive upper residues (xᵢ, yᵢ) that are smaller than a predefined expansion factor times the corresponding modulus (xᵢ,yᵢ<φMᵢ) and is configured to produce upper residues (zᵢ) of the product of the received upper residues (Z) that are smaller than the predefined expansion factor times the corresponding modulus (zᵢ<φMᵢ).

2. A calculating device as in claim 1, wherein the upper multiplication routine is further configured to compute the product of the first (x) and second integer (y) modulo a further modulus (N).

3. A calculating device as in claim 1, wherein the expansion factor is 2 or more than 2.

4. A calculating device as in claim 1, wherein the lower multiplication routine is configured to compute the arithmetical product (h) of the two further-represented upper residues modulo an upper modulus (Mᵢ) by component-wise multiplication of lower residues of the first upper residue and corresponding lower residues of the second upper residue followed by a modular reduction modulo the corresponding modulus (Mⱼ).

5. A calculating device as in claim 4, wherein the modular reduction comprises computing the rounded-down division └h/Mⱼ┘ of the arithmetical product (h) and the corresponding modulus (Mⱼ).

6. A calculating device as in claim 1, comprising a table storage wherein the lower multiplication routine comprises looking-up the product of lower residues in a modular multiplication result look-up table stored in the table storage, and wherein the look-up table for the lower moduli are at least as large as the largest lower modus.

7. A calculating device as in claim 1, wherein a further represented upper residue (X) is represented in Montgomery representation (x), the Montgomery representation (x) being said upper residue (X) multiplied with a predefined Montgomery constant (m) modulo the corresponding modulus (Mⱼ, αⱼ=mx mod Mⱼ), the lower multiplication routine being configured to receive the two further-represented upper residues in Montgomery representation as two sequences of lower residues, and is configured to produce the product in Montgomery representation.

8. A calculating device as in claim 7, wherein the lower multiplication routine is configured to compute an integer u satisfying h=uMⱼ=zm, for some z, wherein h=xy, and to compute z=(h+uMⱼ)/m.

9. A calculating device as in claim 8, wherein the lower layer RNS is an extended residue number system wherein the sequence of multiple lower moduli (m₁, . . . , mₖ) is the base sequence, and the extended RNS has an extension sequence of a further multiple of lower moduli (m_{K+1}, . . . , m_{L}), the Montgomery constant (m) being the product of the base sequence of multiple lower moduli, computing the z=(h+u)/m is done for the extension sequence, followed by base extension to the base sequence

10. A calculating device as in claim 9, wherein first the residues for z=(h+u)/m are computed with respect to the further multiple of lower moduli (m_{K+1}, . . . , m_{L}), and subsequently the residues for z with respect to a base sequence of lower moduli (m₁, . . . , m_{K}) are computed by base extension.

11. A calculating device as in claim 1, wherein the lower multiplication routine is configured to compute a modular sum-of-products (z=Σᵢ₌₀^{K}xⁱc^{j} mod Mⱼ) modulo an upper modulus (Mⱼ) by first computing the sum of products (h=Σᵢ₌₀^{K}xⁱd^{j}; with d^{j}=mc^{j}) by component-wise multiplication and addition of lower residues representing the upper residues (xⁱ) and (dⁱ) followed by a final modular reduction modulo the corresponding modulus (Mⱼ).

12. A calculating device as in claim 1, wherein the sequence of upper moduli comprises a redundant modulus for base-extension, the redundant modulus being the product of one or more lower moduli of the sequence of multiple lower moduli.

13. A calculating device as in claim 1, wherein a sequence of constants Hₛ is defined for the moduli Mₘ at least for the upper layer, so that a residue xₛ is represented as a pseudo-residue yₛ such that xₛ=Hₛyₛ mod Mₛ, wherein at least one Hₛ differs from m⁻¹ mod Mₛ.

14. An electronic calculating method for calculating the product of integers, the method comprising
storing integers in a multi-layer residue number system (RNS) representation, the multi-layer RNS representation having at least an upper layer RNS and a lower layer RNS, the upper layer RNS being a residue number system for a sequence of multiple upper moduli (Mᵢ), the lower layer RNS being a residue number system for a sequence of multiple lower moduli (mᵢ), an integer (x) being represented in the storage by a sequence of multiple upper residues (xᵢ= [symbol] x [symbol] _{M}_{ᵢ}) modulo the sequence of upper moduli (Mᵢ), upper residues (xⱼ) for at least one particular upper modulus (Mⱼ) being further-represented in the storage by a sequence of multiple lower residues ( [symbol] xⱼ [symbol] ) of the upper residue (xⱼ) modulo the sequence of lower moduli (mᵢ), wherein at least one of the multiple lower moduli (mᵢ) does not divide a modulus of the multiple upper moduli (Mⱼ),
computing the product of a first integer (x) and a second integer (y), the first and second integer being stored in the storage according to the multi-layer RNS representation, the computing comprising a at least a lower multiplication part and an upper multiplication part,
the lower multiplication part computing the product of two further-represented upper residues (xⱼ, yᵢ) corresponding to the same upper modulus (Mⱼ) modulo said upper modulus (Mⱼ),
the upper multiplication part computing the product of the first and second integer by component-wise multiplication of upper residues of the first integer (xᵢ) and corresponding upper residues of the second integer (yᵢ) modulo the corresponding modulus (Mᵢ), wherein the upper multiplication routine calls upon the lower multiplication routine to multiply the upper residues that are further-represented, wherein the upper multiplication part is configured to receive upper residues (xᵢ, yᵢ) that are smaller than a predefined expansion factor times the corresponding modulus (xᵢ,yᵢ<φMᵢ) and is configured to produce upper residues (zᵢ) of the product of the received upper residues (z) that are smaller than the predefined expansion factor times the corresponding modulus (zᵢ<φMᵢ).

15. A computer readable medium comprising transitory or non-transitory data representing instructions to cause a processor system to perform the method according to claim 14.
